(19) United States
(12) Patent Application Publication
(10) Pub. No.: US 2009/0203415 A1
(43) Pub. Date: Aug. 13, 2009

(54) METHOD AND SYSTEM FOR PLAYING A MATCHING GAME

(76) Inventor: Sal Falciglia, SR., Ridgewood, NJ (US)

Correspondence Address: CARTER, DELUCA, FARRELL & SCHMIDT, LLP, 445 BROAD HOLLOW ROAD, SUITE 420, MELVILLE, NY, 11747, US

(21) Appl. No.: 12/347,038

(22) Filed: Dec. 31, 2008

Related U.S. Application Data
(63) Continuation of application No. 12/029,924, filed on Feb. 12, 2008.

(51) Int. Cl. G06F 19/00

(52) U.S. Cl. 463/11

(57) ABSTRACT

A system and method for playing a matching game includes displaying a layout of graphical elements and a set of game reels; receiving at least one input and displaying via a graphical user interface a graphical element in each of the set of game reels; receiving a first selection input corresponding to one of a graphical element of the layout of graphical elements and a graphical element of the set of game reels; receiving a second selection input corresponding to one of a graphical element of the layout of graphical elements and a graphical element of the set of game reels, wherein the first selection input and the second selection input corresponding to two different graphical elements; determining whether the two different graphical elements match in accordance with predetermined rules; removing the two different graphical elements from the graphical user interface if they form a match and not removing the two different graphical elements if they do not form a match; awarding points if the two different graphical elements form a match and are removed from the graphical user interface; and repeating at least the last four steps until a predetermined criterion is met.

### PRIORITY

The present application is a continuation application to an application filed on Feb. 12, 2008 and assigned U.S. application Ser. No. 12/029,924; the entire contents of which are incorporated herein by reference.

### BACKGROUND

1. Technical Field

The present disclosure relates to matching games, and, in particular, to a system and method for playing a matching game. More particularly, the present disclosure relates to a variation of the game Mahjong solitaire.

2. Description of Related Art

Mahjong solitaire is a solitaire matching game that uses a set of Mahjong tiles rather than cards. It is also known as Shanghai solitaire, electronic or computerized mahjong, The tiles come from the four-player game popular in Asia known as Mahjong. The 144 tiles are arranged in a multi-layer layout (typically, four layers) with their faces upwards. A tile that can be moved left or right without disturbing other tiles is said to be open or exposed. The goal is to match open pairs of identical tiles and remove them from the board, exposing the tiles under them for play. The game is finished when all pairs of tiles have been removed from the board or when there are no exposed pairs remaining.

Mahjong solitaire can be played either solo or with a partner, in which case the aim is to accumulate the most pairs, to be the last one to match a pair, or to score the most points. Points are gained for each pair removed, with bonus points for removing matched pairs in sequence or removing pairs in sequence that are parts of sets. Using traditional mahjong tiles, the sets include the dragons, the flowers, the seasons, and the winds (with the winds being worth the most bonus points).

### SUMMARY

The present disclosure relates to matching games, and, in particular, to a system and method for playing a matching game on a computing device.

More particularly, the present disclosure relates to a variation of the game Mahjong solitaire. The game is described herein with the use of traditional Mahjong tiles (144 tiles) as the matching graphical elements. It is, however, contemplated that the game can be designed to operate with different matching graphical elements, such as standard Poker playing cards.

The matching game according to the present disclosure is enabled by a set of programmable instructions configured for being executed by at least one processor of a computing device or system. A graphical user interface is provided and it displays various elements, such as a game clock for clocking game play from start to finish; a set of game reels (e.g., five game reels) capable of “spinning”, similar to spinning reels of a slot machine, to display a set of graphical elements, such as five Mahjong tiles, upon selection of a “SPIN” icon; and a layout of graphical elements or a Mahjong tile layout. The tile layout can differ in pattern, size and height.

During game play, a player aims to earn points by matching a corresponding Mahjong tile from the set of displayed Mahjong tiles with a corresponding Mahjong tile in the Mahjong tile layout also displayed by the graphical user interface. Additionally, as with traditional Mahjong solitaire, the player also aims to match corresponding pairs of Mahjong tiles in the Mahjong tile layout to earn points. The Mahjong tile layout can consist of multiple layers or one layer depending on a selected skill level or programming instructions.

In the case of multiple layers, only a tile which is “free” can be matched with another “free” tile in the tile layout or with a tile displayed by one of the game reels. A tile is “free” when (1) no other tile is lying above or is partially covering it; and (2) no other tile is lying to the left or to the right (it can “slide” in one or both of these directions).

The player's goal is to match as many tiles as possible displayed by the tile layout in order to have them removed from the tile layout. The ultimate goal, which is not always attainable due to the game rules, is to match and remove all the tiles of the tile layout using a predetermined number of spins (e.g., 15 spins) and a predetermined amount of time. If this is accomplished the player earns a predetermined number of points (e.g., 10,000 points) and a time bonus in the form of additional points based on the time elapsed from start to finish. The points correspond to the player's score which is displayed by a score counter.

The matching rules for the game according to the present disclosure are those of traditional Mahjong solitaire where two tiles which are identical can be matched. There is an exception to this rule regarding the flowers and seasons tiles; they are non-identical matching tiles and belong to the same type. All the flowers tiles match one another and all the seasons tiles match one another. In particular, like ball tiles can be matched with like ball tiles, bamboo tiles can be matched with like bamboo tiles, character tiles can be matched with like character tiles, wind tiles can be matched with like wind tiles, dragon tiles can be matched with like dragon tiles, seasons tiles can be matched with any other seasons tile, and flower tiles can be matched with any other flower tile.

During game play, the player can select a “HINT” icon for instructing the computing device to provide a matching hint by highlighting or otherwise indicating a pair of matching Mahjong tiles. If there are no Mahjong tiles that can be matched, a window appears displaying the message “You need to take another spin.” This message conveys to the player that the “SPIN” icon needs to be selected to display a new set of Mahjong tiles by the set of game reels. A spin counter is then updated indicating the number of remaining spins. The game continues as before using the newly displayed tiles to make matches between tiles.

If five consecutive matches are made without the player selecting the “SPIN” or “HINT” icons, the player is awarded points for obtaining a so-called SLINGO®. If consecutive SLINGOs are obtained (a chain of SLINGOs) by the player matching multiples of five consecutive matches (e.g., 5, 10, 15, . . . consecutive matches) without selecting the “SPIN” or “HINT” icons, the player earns additional points for this achievement depending on how many consecutive SLINGOs were obtained (e.g., 2, 3, 4, . . . consecutive SLINGOs). A match counter displays how many consecutive matches have been made. The match counter resets to zero matches, if the “HINT” or “SPIN” icons are selected or the match counter counts five consecutive matches (i.e., a SLINGO® is obtained).

A “PAUSE” icon is also displayed by the graphical user interface. When selected by the player, game play is paused, the tile layout is shaded dark such that the player can not view the tile layout, and the game clock is stopped. The tile layout is revealed and the game clock starts clocking again after the “PAUSE” icon is reselected.

In one aspect of the present disclosure, a method of playing a matching game includes the steps of displaying a layout of graphical elements and a set of game reels; receiving at least one input and displaying via a graphical user interface a graphical element in each of the set of game reels; receiving a first selection input corresponding to one of a graphical element of the layout of graphical elements and a graphical element of the set of game reels; receiving a second selection input corresponding to one of a graphical element of the layout of graphical elements and a graphical element of the set of game reels, wherein the first selection input and the second selection input corresponding to two different graphical elements; determining whether the two different graphical elements match in accordance with predetermined rules and whether each of the two different graphical elements can be selected in accordance with the predetermined rules, wherein a graphical element of the layout of graphical elements can be non-selectable in accordance with the predetermined rules; removing the two different graphical elements from the graphical user interface if they form a match and can both be selected, and not removing the two different graphical elements if they do not form a match and at least one of the two different graphical elements is non-selectable in accordance with the predetermined rules; awarding points if the two different graphical elements form a match and are removed from the graphical user interface; and repeating at least the last four steps until a predetermined criterion is met. The predetermined criterion can be one of the following: all graphical elements of the layout are matched; no remaining graphical elements can be matched; a game clock clocks a predetermined time period; a predetermined number of spins are used for displaying a graphical element in at least one of the set of game reels; and a predetermined number of spins and additional awarded spins are used for displaying a graphical element in at least one of the set of game reels.

The method further includes the step of awarding points for each match. It is contemplated that the points awarded are different based on the type or rank of graphical elements or Mahjong tiles matched.

The method further includes the steps of counting the number of consecutive matches; determining if a predetermined number of consecutive matches is achieved; and awarding points if a predetermined number of consecutive matches is achieved. The method further includes the step of resetting a match counter corresponding to the number of consecutive matches to zero if an input is received requesting a matching hint or spin prior to achieving the predetermined number of consecutive matches, or the predetermined number of consecutive matches is achieved. The method further includes the steps of counting the number of consecutive times the predetermined number of consecutive matches is achieved and awarding points after each such achievement. The method further includes the steps of receiving a hint request input and identifying (e.g., highlighting) two matching graphical elements capable of being matched after receiving the hint request input or displaying a message if no graphical elements can be matched. The message informs the user that no graphical elements can be matched. The user can then select an icon for causing at least one game reel of the set of game reels to display a new graphical element.

In another aspect of the present disclosure, a system is provided having a display and at least one processor configured for executing a set of programmable instructions for displaying the graphical user interface on the display and enabling play of the game described herein in accordance with the present disclosure. The display could be a touch screen display. The system can be a network system having a server accessible via a network by at least one computing device, such as a personal computer, and a mobile computing device.

In yet another aspect of the present disclosure, a computer-readable medium is provided storing a set of programmable instructions configured for execution by at least one processor for enabling play of the game described herein in accordance with the present disclosure. The computer-readable medium can be, for example, a CD-ROM, a hard drive, a smart card, and a flash memory media.

### BRIEF DESCRIPTION OF THE DRAWINGS

FIGS. 1-100 shows sequential screen views of a graphical user interface during play of the game in accordance with the present disclosure; and

FIG. 101 shows a block diagram of a system for playing the game in accordance with the present disclosure.

### DETAILED DESCRIPTION

Referring to the drawings, a description is provided herein of a method and system for playing a matching game in accordance with the present disclosure. The matching game according to the present disclosure is enabled by a set of programmable instructions configured for being executed by at least one processor of a computing device.

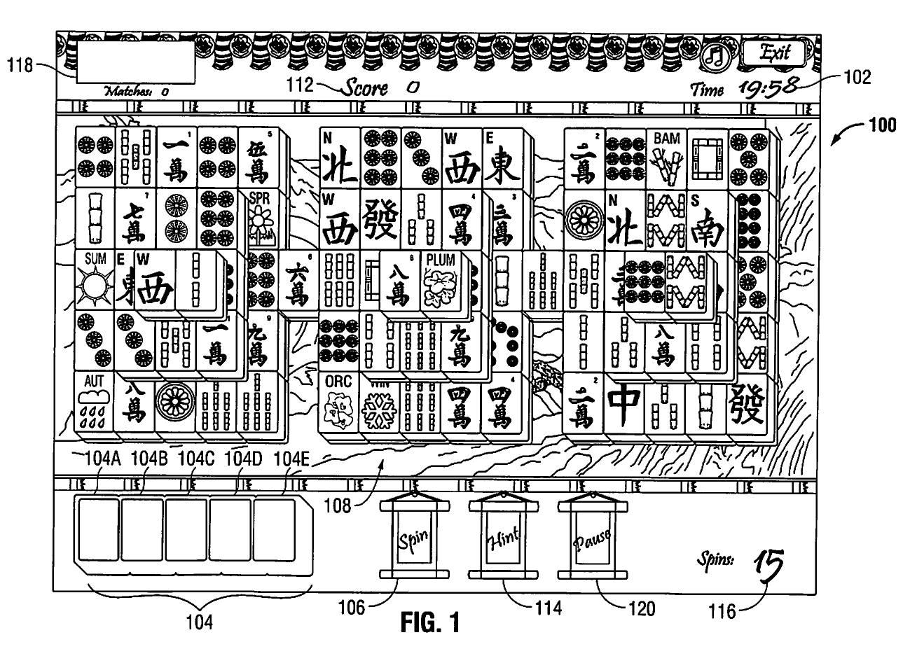

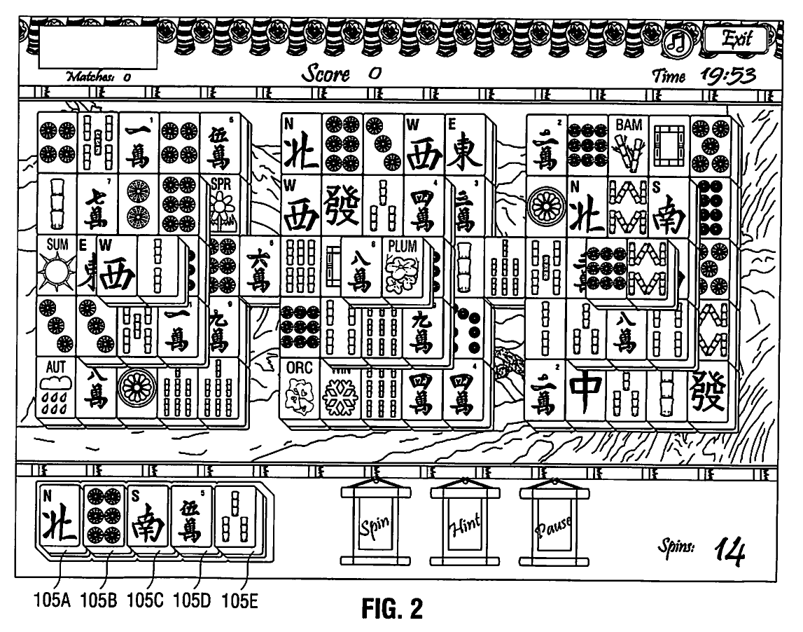

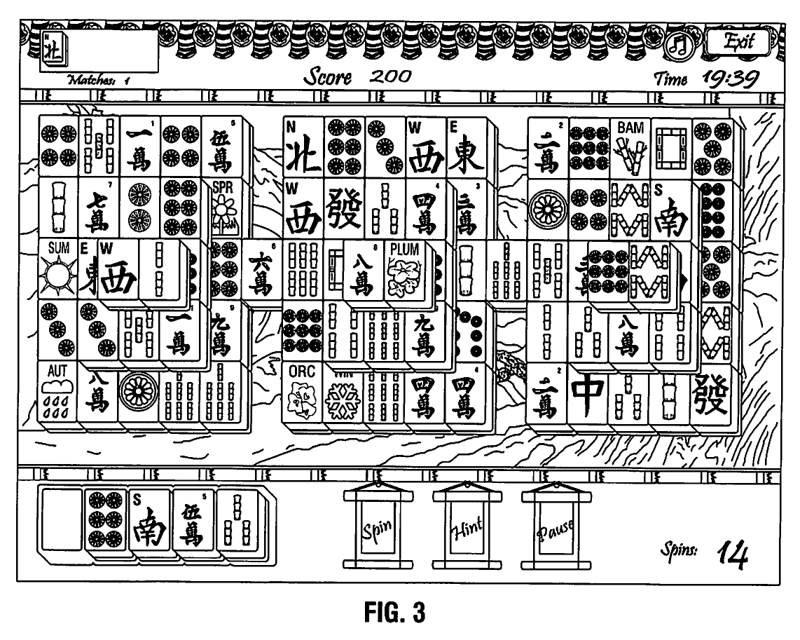

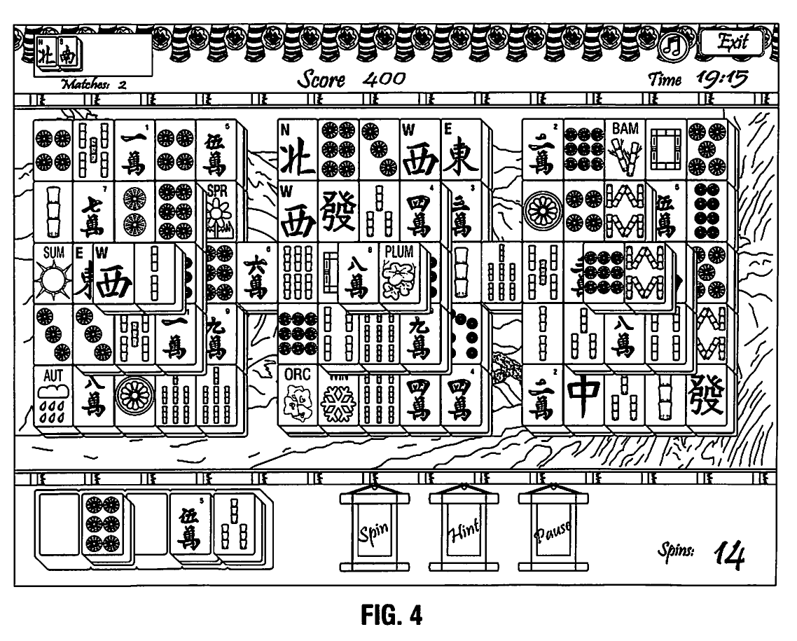

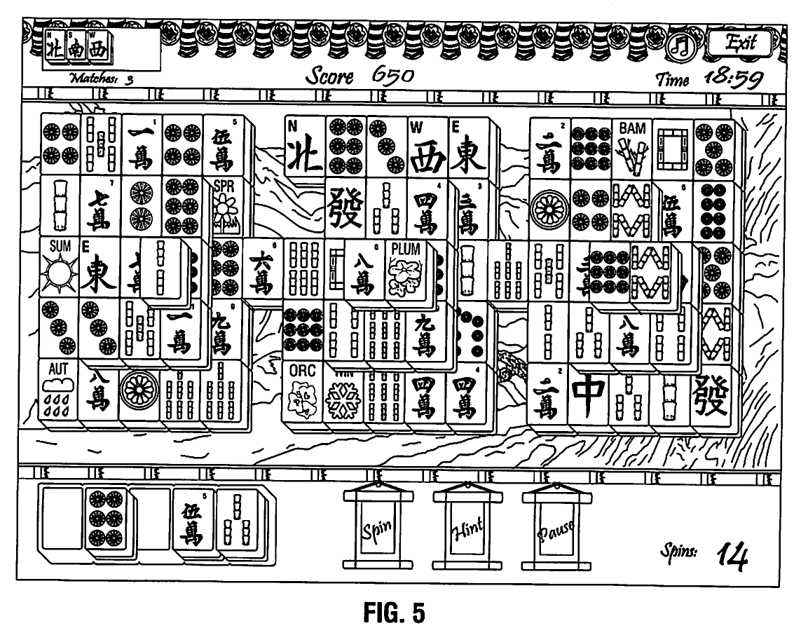

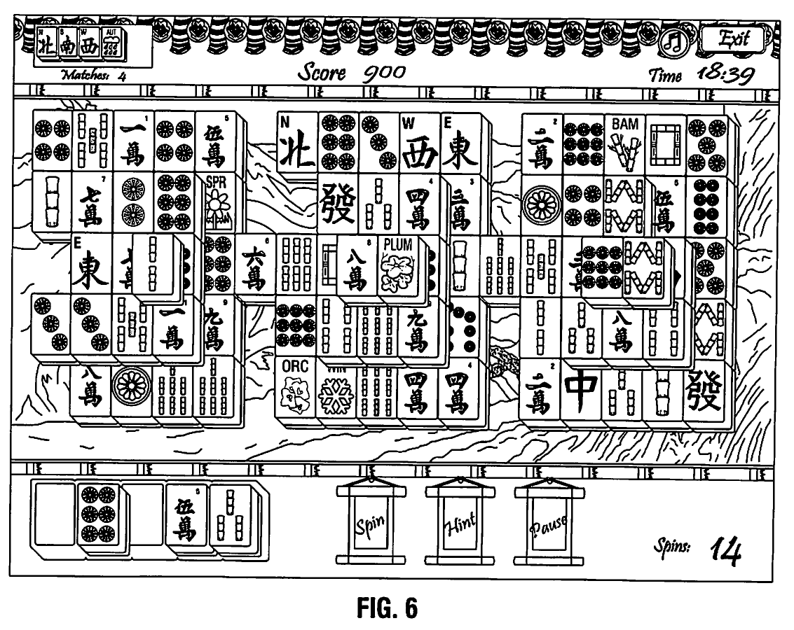

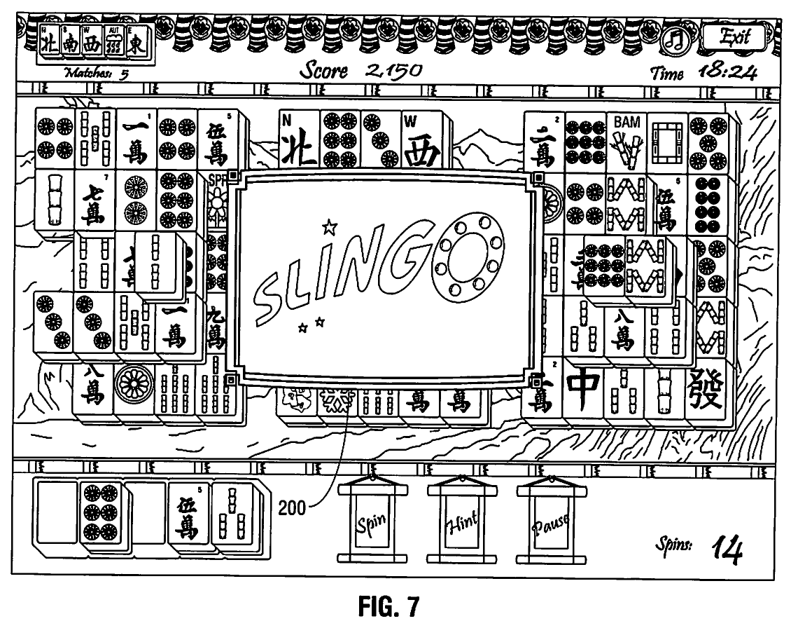

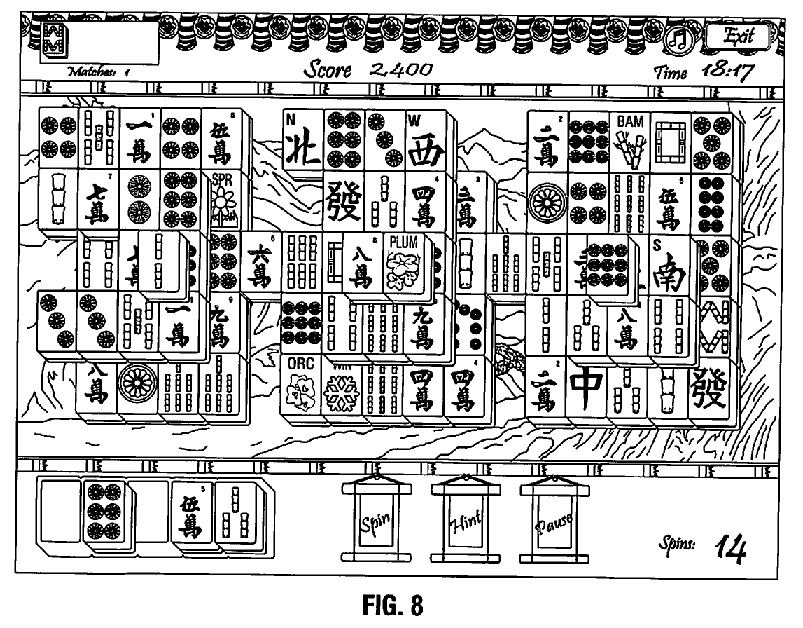

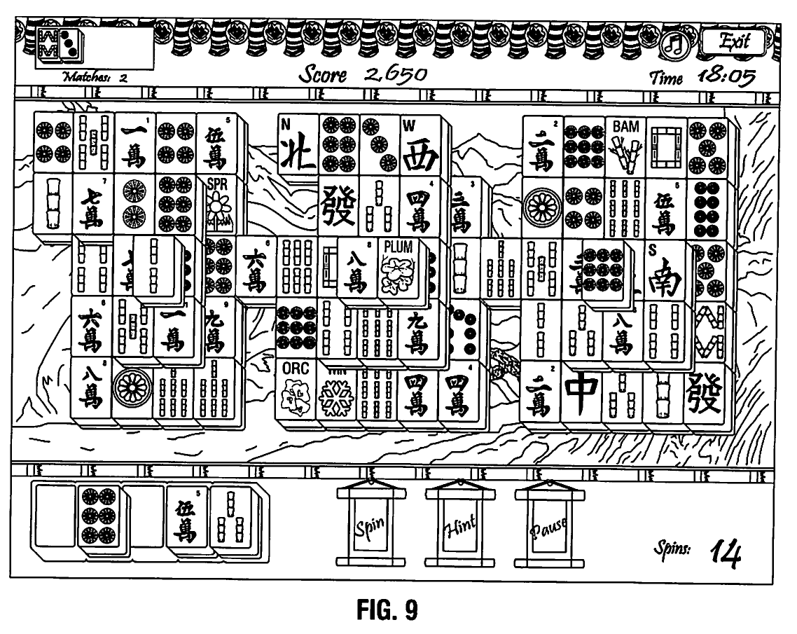

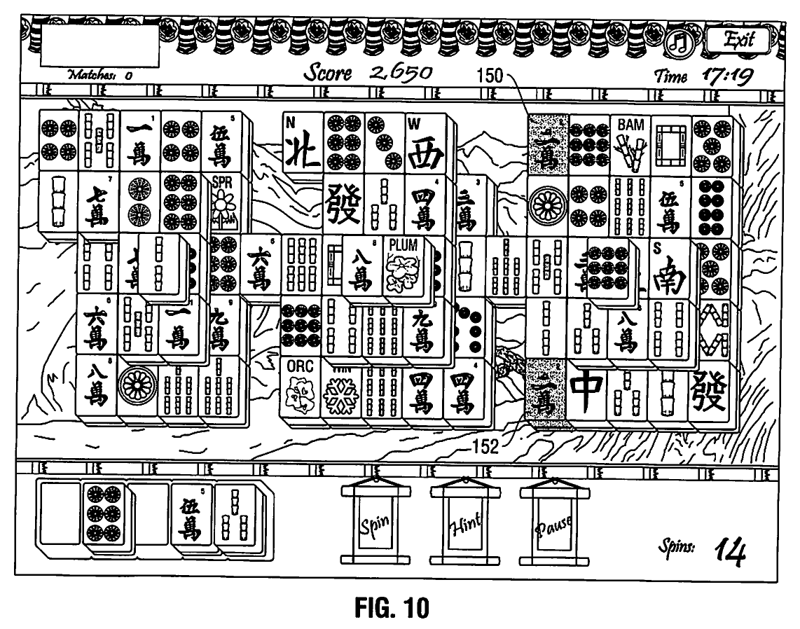

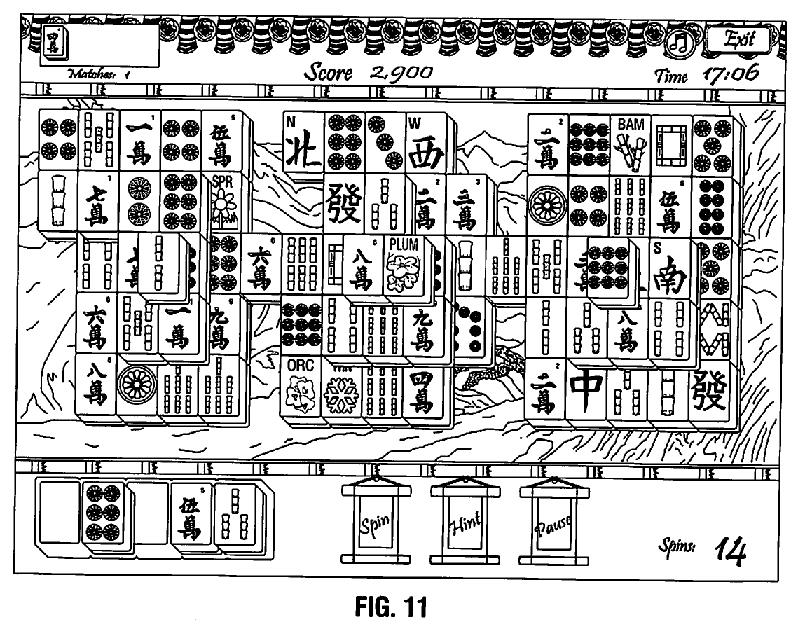

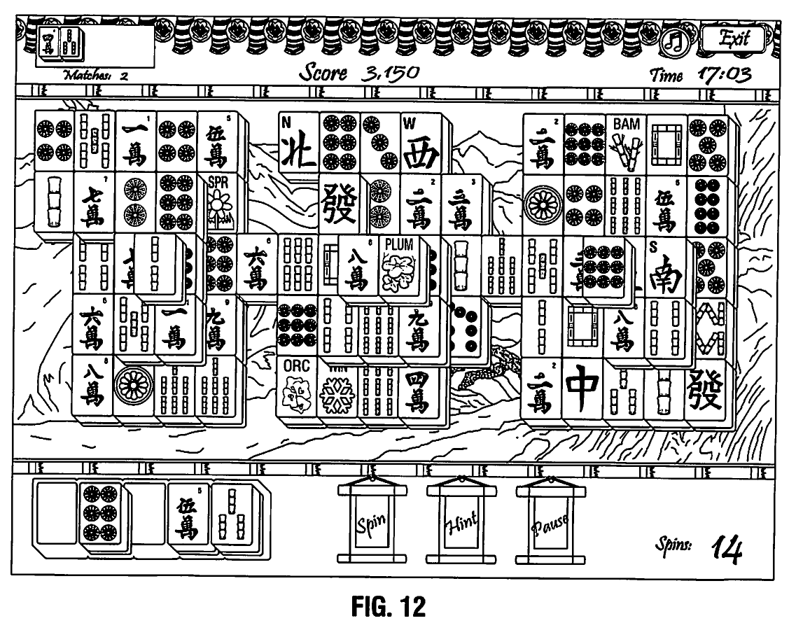

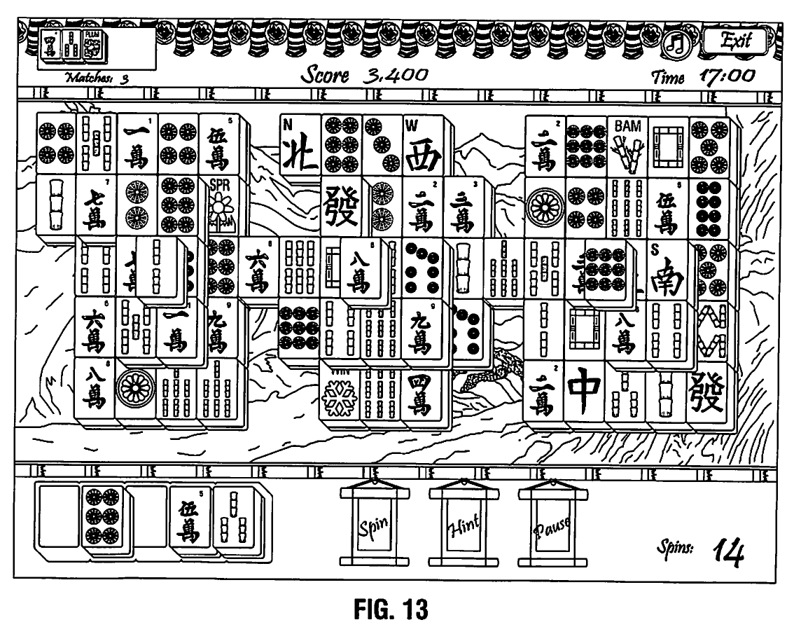

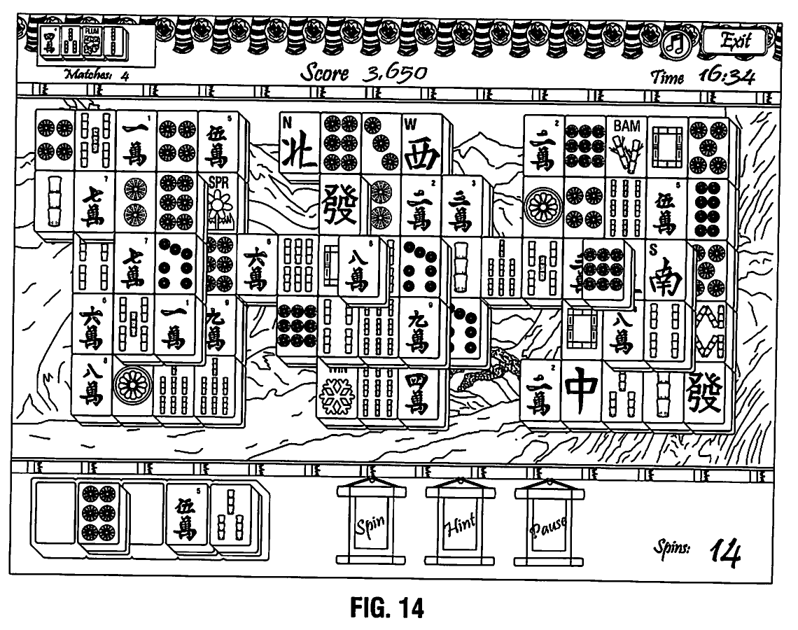

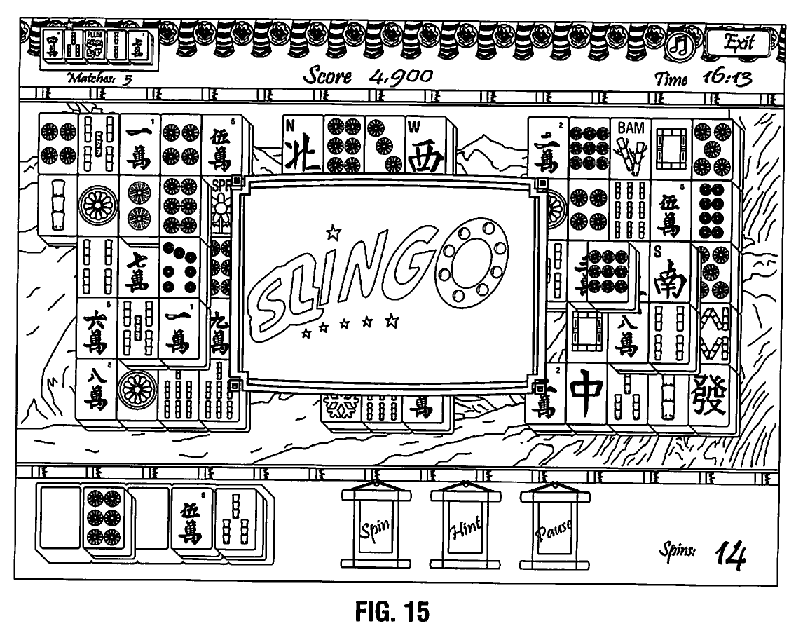

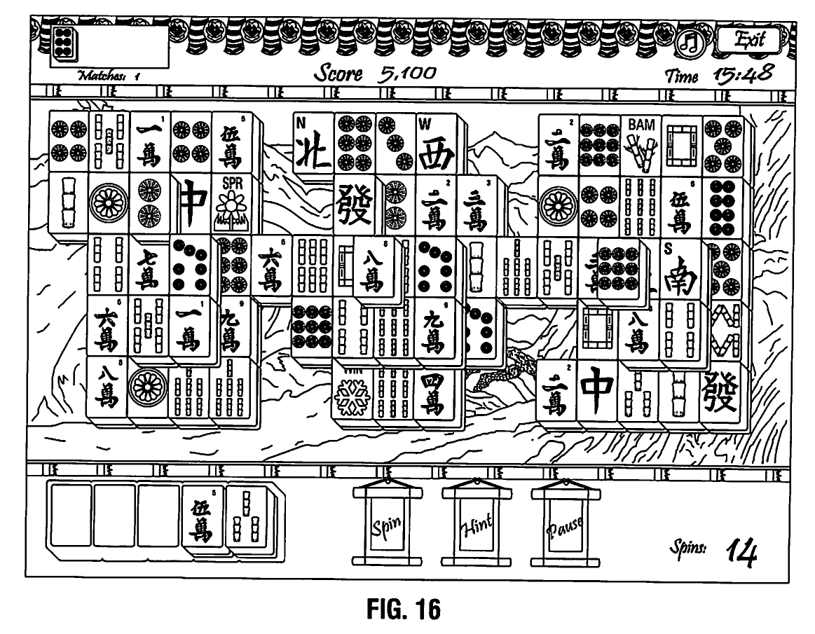

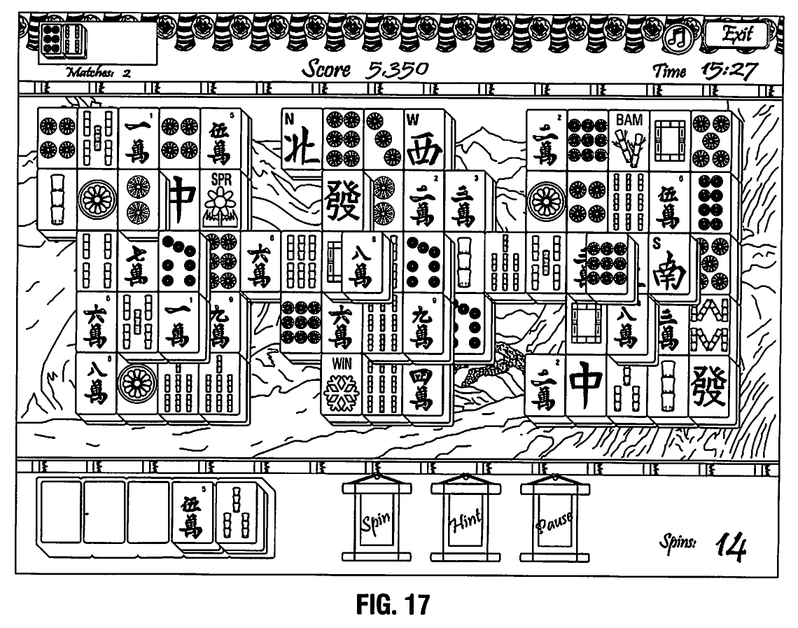

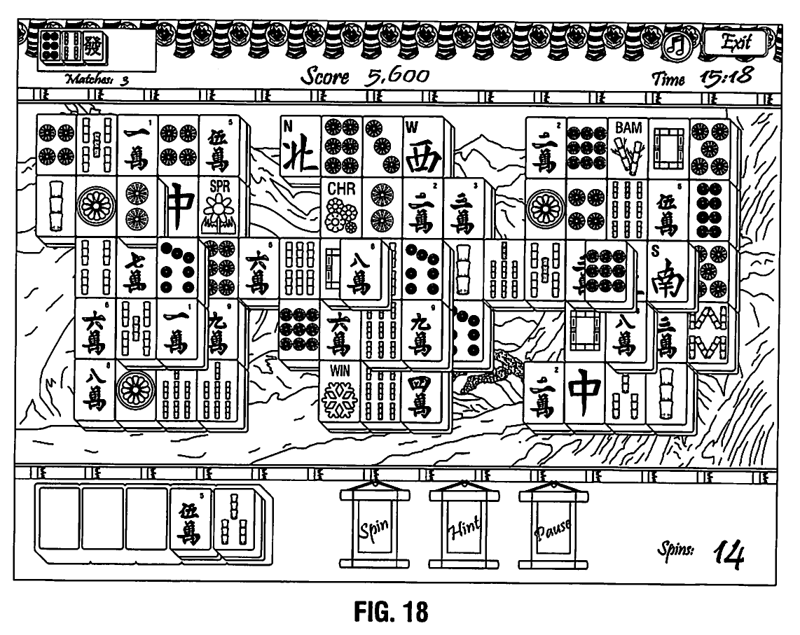

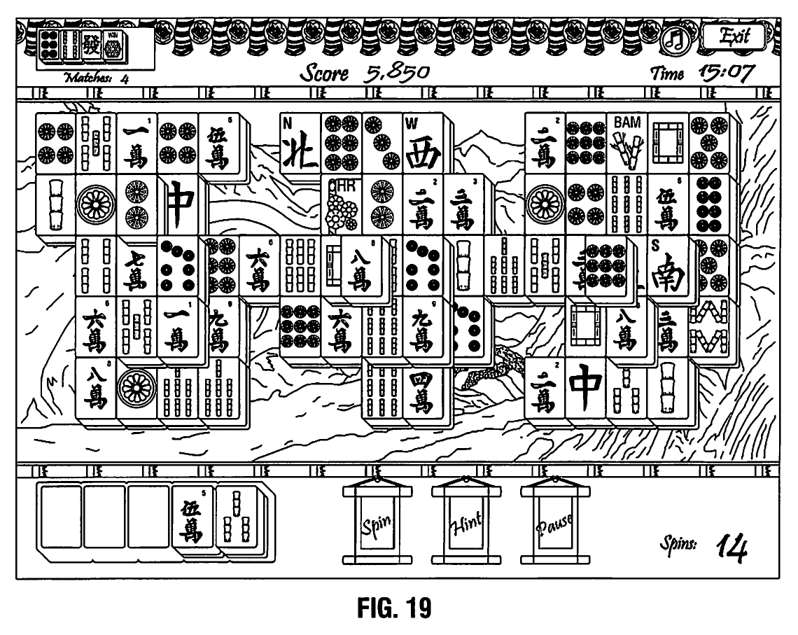

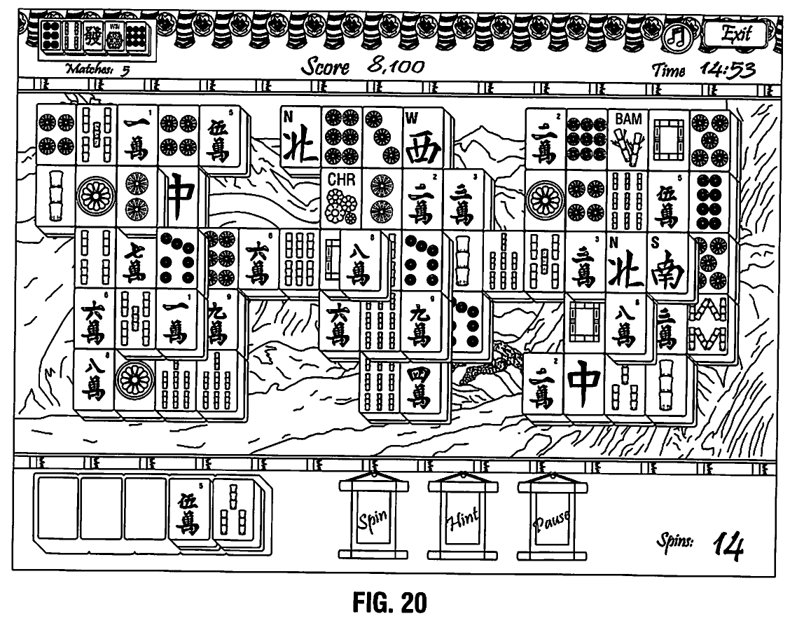

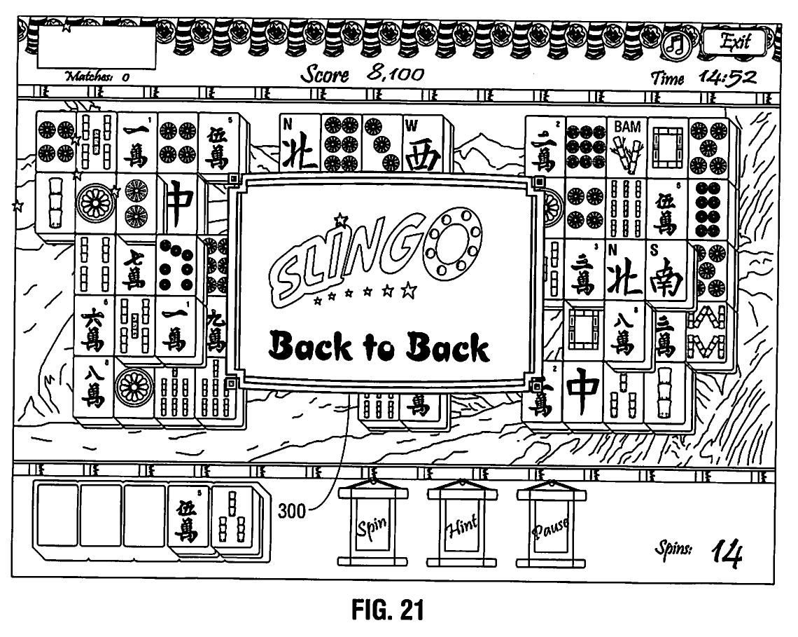

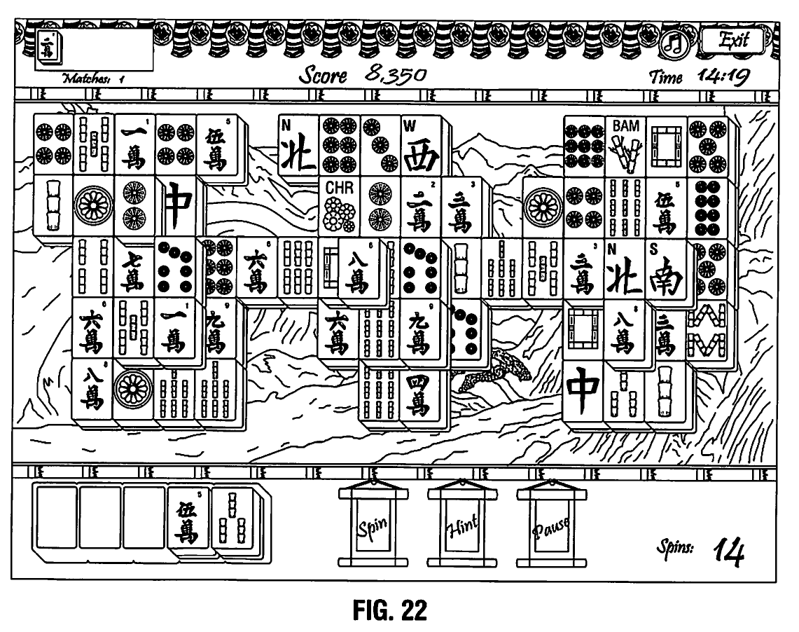

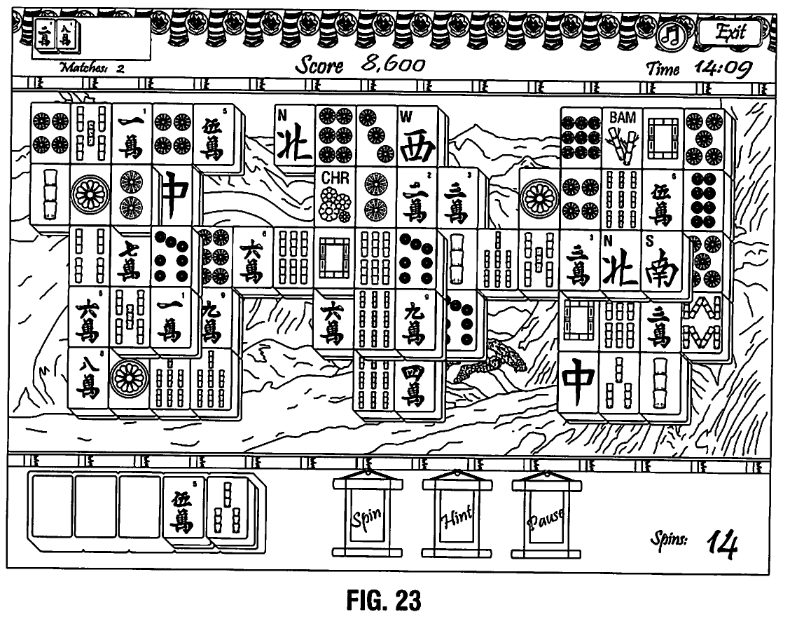

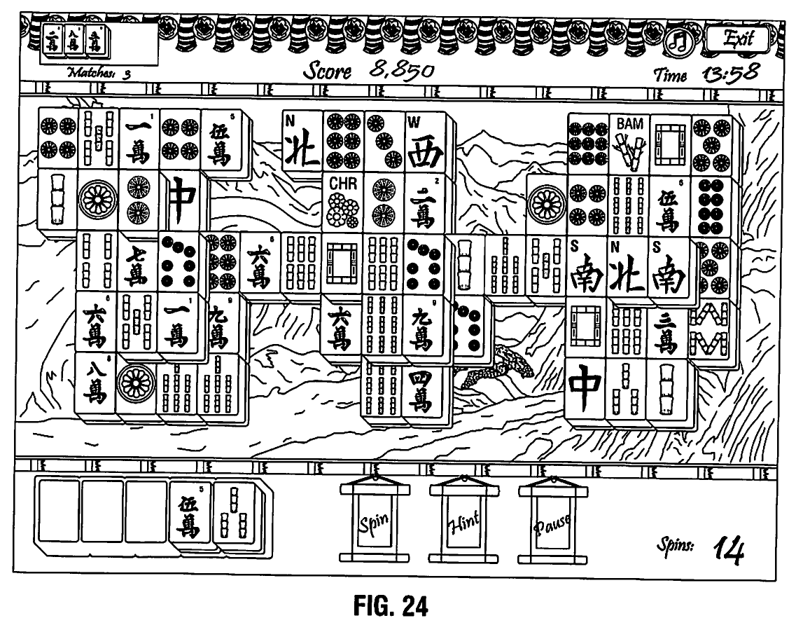

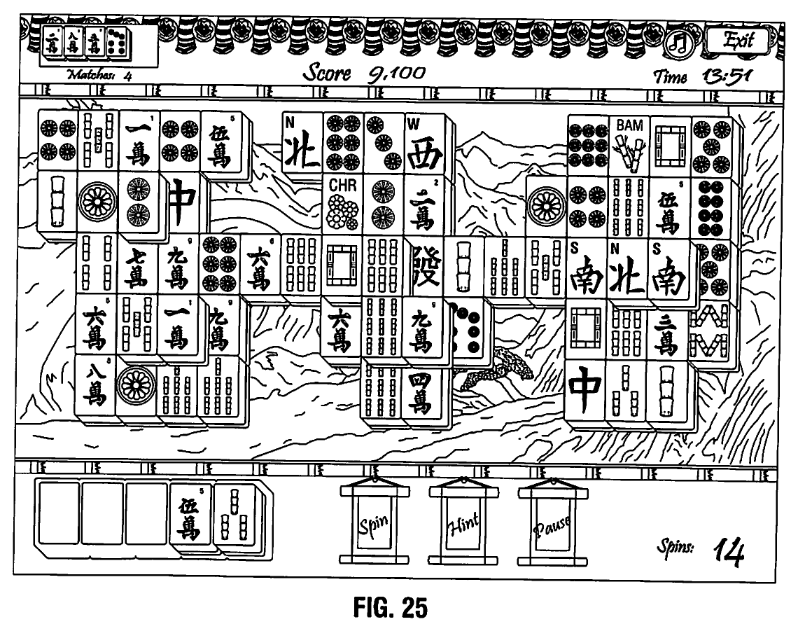

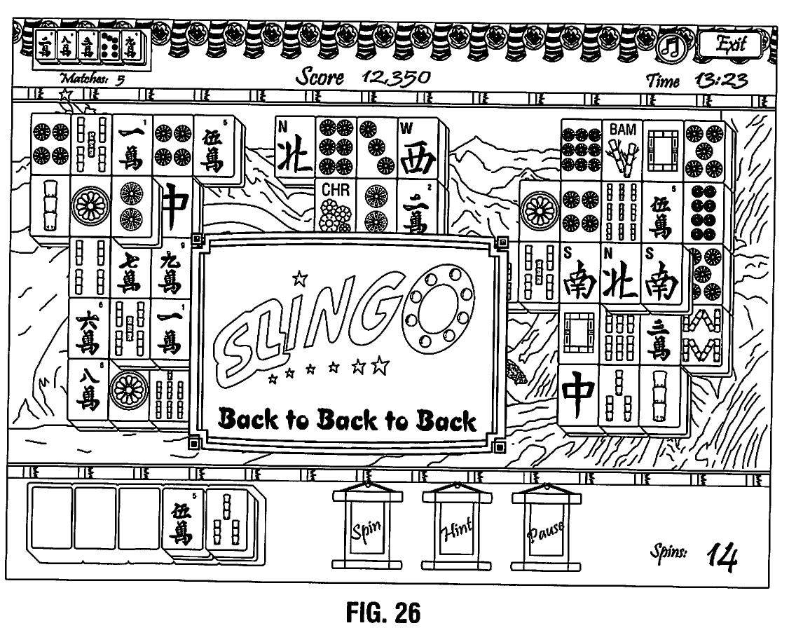

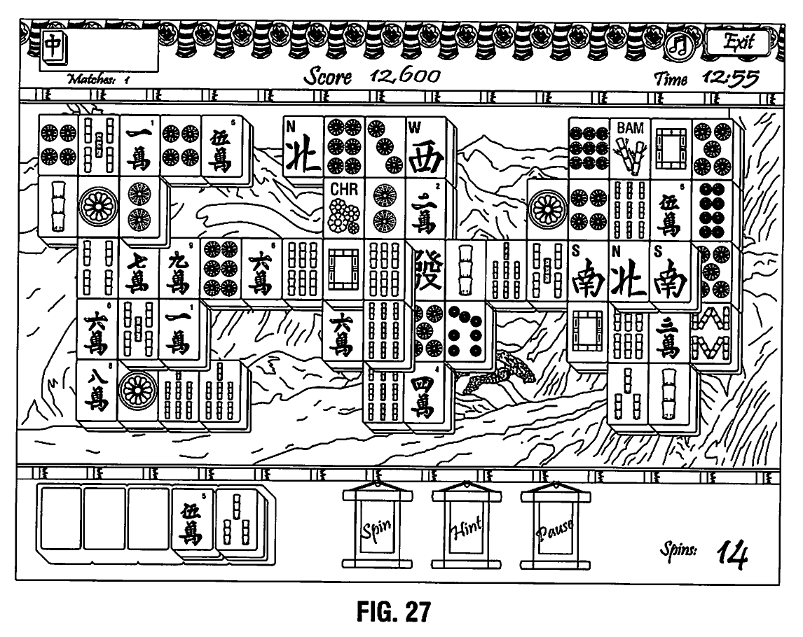

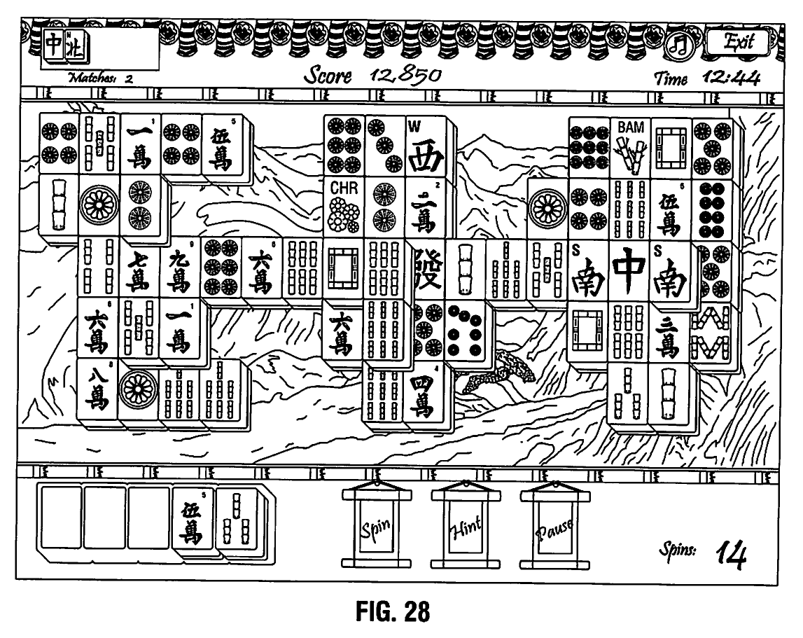

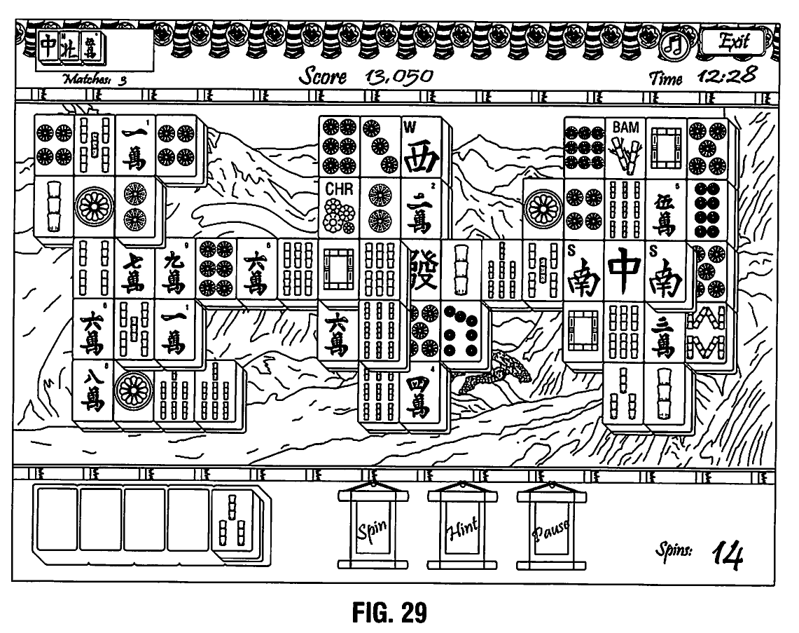

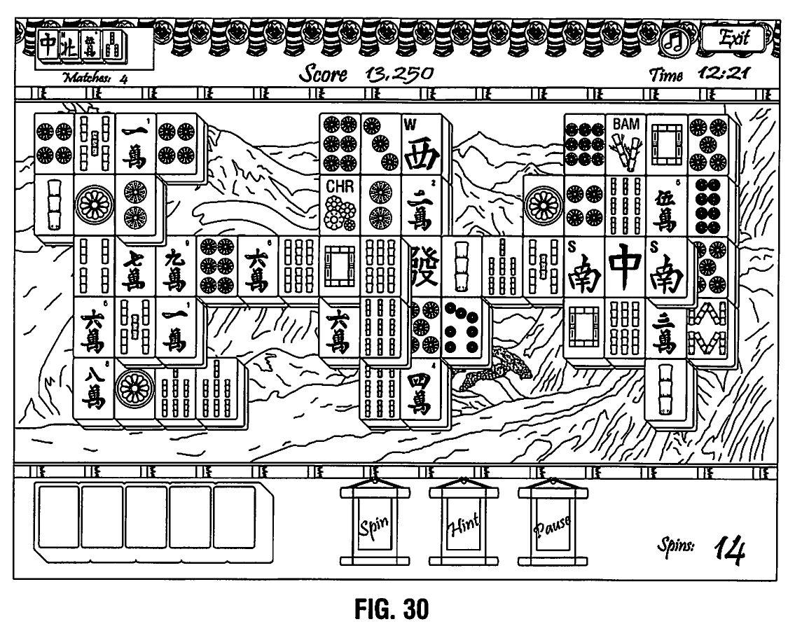

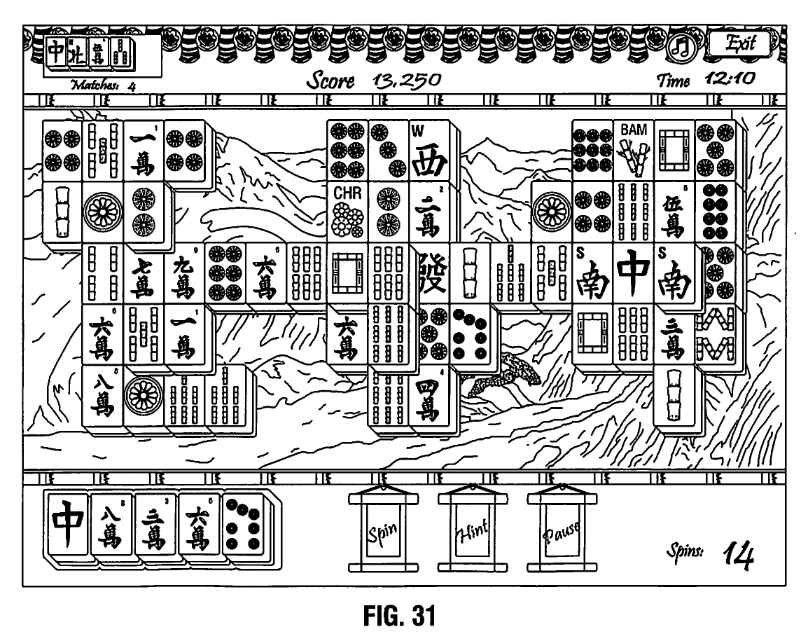

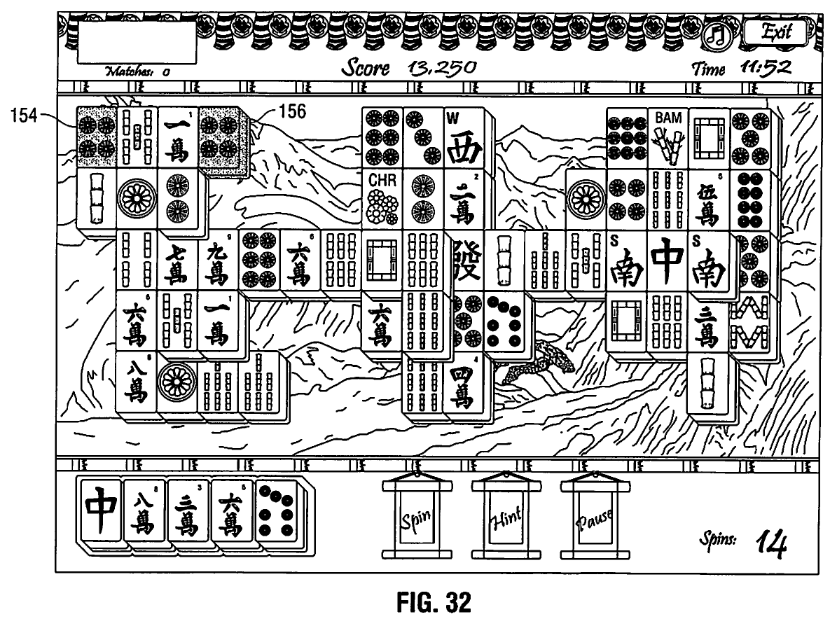

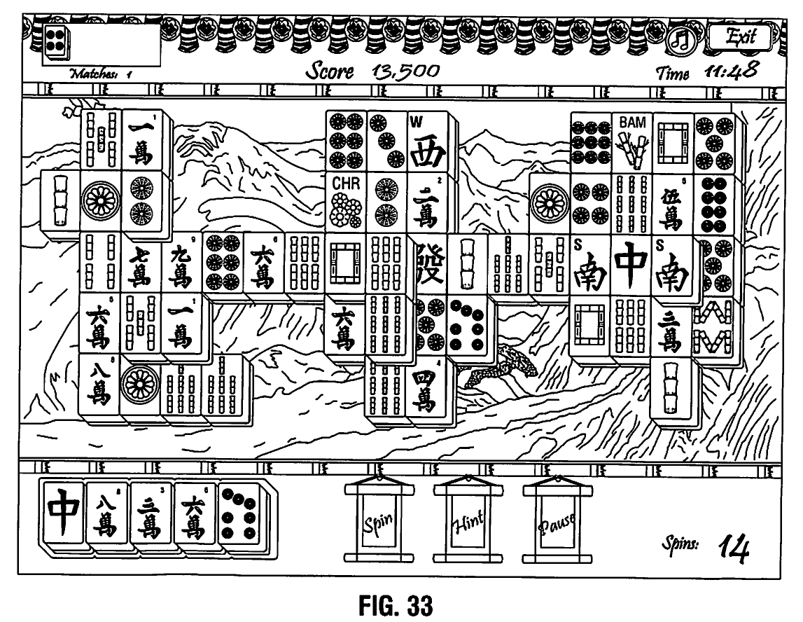

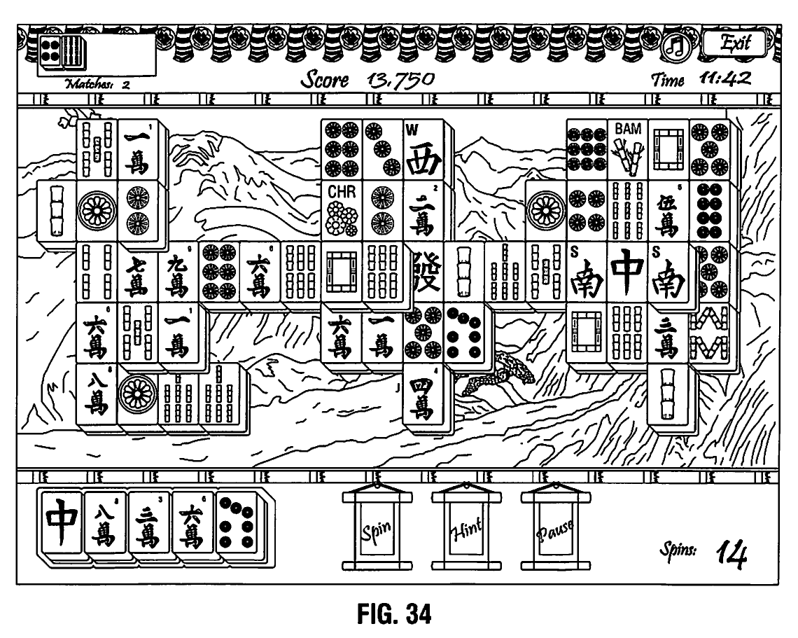

FIG. 1 depicts a graphical user interface 100. Graphical user interface 100 can be displayed by a display, such as a touch screen display, of a computing device or system, such as a personal computer system, network computing system, mobile computing device, stand-alone casino machine, etc.

Graphical user interface 100 displays various elements, such as a game clock 102 for clocking game play from start to finish; a set of game reels 104 (e.g., five game reels 104A-E) capable of “spinning”, similar to spinning reels of a slot machine, to display a set of graphical elements 105A-E (FIG. 2), such as five Mahjong tiles, upon selection of a “SPIN” icon 106; and a layout 108 of graphical elements or a Mahjong tile layout. The tile layout 108 can differ in pattern, size and height.

During game play, a player aims to earn points by matching a corresponding Mahjong tile from the set of displayed Mahjong tiles 105A-E with a corresponding Mahjong tile 110 in the Mahjong tile layout 108 also displayed by the graphical user interface 100. It is contemplated that in one embodiment of the game, the player is awarded a free spin and/or points for matching five tiles displayed by the games reels 104A-E with corresponding matching tiles in the Mahjong tile layout 108 in a row (i.e., sequentially). Additionally, as with traditional Mahjong solitaire, the player also aims to match corresponding pairs of Mahjong tiles in the Mahjong tile layout 108 to earn points.

In an alternate embodiment of the matching game according to the present disclosure, the only matches possible are matching a corresponding Mahjong tile from the set of displayed Mahjong tiles 105A-E with a corresponding Mahjong tile 110 in the Mahjong tile layout 108 (i.e., matches between corresponding pairs of Mahjong tiles in the Mahjong tile layout 108 are not allowed). It is also contemplated that in this alternate embodiment, the matches are made automatically, following the display of the set of Mahjong tiles 105A-E by the set of game reels 104A-E, by the processor without the player being required to make any tile selections.

The game described herein can also be designed such that one or more additional tiles are concealed underneath one or more tiles of the set of five displayed Mahjong tiles 105A-E. The concealed tiles are revealed when the displayed tile is selected and matched with a corresponding matching tile in the tile layout 108.

The Mahjong tile layout 108 can consist of multiple layers or one layer depending on a selected skill level or programming instructions._In the case of multiple layers, only a tile 110 which is “free” can be matched with another “free” tile 110 in the tile layout 108 or with a tile 105 displayed by one of the game reels 104. A tile 110 is “free” when (1) no other tile 110 is lying above or is partially covering it; and (2) no other tile 110 is lying to the left or to the right (it can “slide” in one or both of these directions).

The player's goal is to match as many tiles 110 as possible displayed by the tile layout 108 in order to have them removed from the tile layout 108. The ultimate goal, which is not always attainable due to the game rules, is to match and remove all the tiles 110 of the tile layout 108 using a predetermined number of spins (e.g., 15 spins) and a predetermined amount of time. If this is accomplished the player earns a predetermined number of points (e.g., 10,000 points) and a time bonus in the form of additional points based on the time elapsed from start to finish. The points correspond to the player's score which is displayed by a score counter 112.

The matching rules for the game according to the present disclosure are those of traditional Mahjong solitaire where two tiles which are identical can be matched. There is an exception to this rule regarding the flowers and seasons tiles; they are non-identical matching tiles and belong to the same type. All the flowers tiles match one another and all the seasons tiles match one another. In particular, like ball tiles can be matched with like ball tiles, bamboo tiles can be matched with like bamboo tiles, character tiles can be matched with like character tiles, wind tiles can be matched with like wind tiles, dragon tiles can be matched with like dragon tiles, seasons tiles can be matched with any other seasons tile, and flower tiles can be matched with any other flower tile. It is envisioned that the matching rules can be modified.

During game play, the player can select a “HINT” icon 114 for instructing the computing device to provide a matching hint by identifying (e.g., highlighting) a pair of matching Mahjong tiles. If there are no Mahjong tiles that can be matched, a window appears displaying the message “You need to take another spin.” This message conveys to the player that the “SPIN” icon 106 needs to be selected to display a new set of Mahjong tiles by the set of game reels 104. A spin counter 116 is then updated indicating the number of remaining spins. The game continues as before using the newly displayed tiles 105A-E to make matches between tiles.

If five consecutive matches are made without the player selecting the “SPIN” icon 106 or “HINT” icon 114, the player is awarded points for obtaining a so-called SLINGO®. If consecutive SLINGOs are obtained (a chain of SLINGOs) by the player matching multiples of five consecutive matches (e.g., 5, 10, 15, . . . consecutive matches) without selecting the “SPIN” icon 106 or “HINT” icon 114, the player earns additional points for this achievement depending on how many consecutive SLINGOs were obtained (e.g., 2, 3, 4, . . . consecutive SLINGOs). A match counter 118 displays how many consecutive matches have been made. The match counter 118 resets to zero matches, if the “HINT” or “SPIN” icons are selected or the match counter 118 counts five consecutive matches (i.e., a SLINGO® is obtained).

A “PAUSE” icon 120 is also displayed by the graphical user interface 100. When selected by the player, game play is paused, the tile layout 108 is shaded dark such that the player can not view the tile layout 108, and the game clock 102 is stopped. The tile layout 108 is revealed and the game clock 102 starts clocking again after the “PAUSE” icon 120 is reselected.

It is contemplated that “free spins”, point multipliers, bonus points, loss of a spin, and other elements, can be “hidden” under random Mahjong tiles in the tile layout 108, as well as the graphical elements 105A-105E. These elements are uncovered and processed when those tiles are matched by the player.

With continued reference to FIG. 1, upon initiation of game play, in an exemplary method of play, the tile layout 108 is displayed, the spin counter 116 displays 15 available spins, the match counter 118 displays zero matches, the score counter 112 displays zero points, and the game clock 102 begins to count down 20 minutes.

The player then selects the “SPIN” icon 106 and the set of game reels 104A-E display five tiles 105A-E as shown by FIG. 2. The spin counter 116 also displays 14 available spins. The player then matches tile 105A with an identical tile on the right side of the tile layout 108 to remove the latter tile from the tile layout 108.

Following the match, FIG. 3 shows tile 105A of game reel 104A and the corresponding matched tile in the tile layout 108 removed. The match counter 118 indicates one match and the player is awarded 200 points as shown by the score counter 112. In the exemplary game described herein with reference to the figures, 250 points are awarded for matching two tiles of the tile layout 108 and 200 points are awarded for matching a tile of the tile layout 108 with a tile displayed by one of the game reels 104A-104E.

FIG. 4 shows the player having made an identical tile match. The player matched tile 105C with an identical tile on the right side of the tile layout 108. The match counter 118 indicates two matches and the player is awarded 200 points to give him a total of 400 points as shown by the score counter 112.

FIG. 5 shows the player having made an identical tile match. The player matched a tile on the left side of the tile layout 108 with an identical tile in the middle of the tile layout 108. The match counter 118 indicates three matches and the player is awarded 250 points to give him a total of 650 points as shown by the score counter 112.

FIG. 6 shows the player having made a tile match of the same type. The player matched the Autumn tile on the left side of the tile layout 108 with the Summer tile also on the left side of the tile layout 108. The match counter 118 indicates four matches and the player is awarded 250 points to give him a total of 900 points as shown by the score counter 112.

FIG. 7 shows the player having made an identical tile match. The player matched a tile on the left side of the tile layout 108 with an identical tile in the middle of the tile layout 108. The match counter 118 indicates five matches (prior to being reset to zero matches) and the player is awarded 250 points and 1000 points for obtaining a SLINGO® to give him a total of 2150 points as shown by the score counter 112. A message window 200 appears indicating the player obtained a SLINGO®.

FIG. 8 shows the player having made an identical tile match. The player matched a tile on the right side of the tile layout 108 with an identical tile also on the right side of the tile layout 108. The match counter 118 indicates one match and the player is awarded 250 points to give him a total of 2400 points as shown by the score counter 112.

FIG. 9 shows the player having made an identical tile match. The player matched a tile on the left side of the tile layout 108 with an identical tile also on the left side of the tile layout 108. The match counter 118 indicates two matches and the player is awarded 250 points to give him a total of 2650 points as shown by the score counter 112.

FIG. 10 shows the player having selected the “HINT” icon 114 and the graphical user interface 100 shows two identical tiles capable of being matched highlighted. These tiles are on the right side of the tile layout 108 and denoted by reference numerals 150 and 152. The match counter 118 is reset to zero due to the hint request.

FIG. 11 shows the player having made an identical tile match. The player matched a tile in the middle of the tile layout 108 with an identical tile also in the middle of the tile layout 108. These matched tiles are not the tiles highlighted after the player selected the “HINT” icon 114. The match counter 118 indicates one match and the player is awarded 250 points to give him a total of 2900 points as shown by the score counter 112.

FIG. 12 shows the player having made an identical tile match. The player matched a tile in the middle of the tile layout 108 with an identical tile on the right side of the tile layout 108. The match counter 118 indicates two matches and the player is awarded 250 points to give him a total of 3150 points as shown by the score counter 112.

FIG. 13 shows the player having made a tile match of the same type. The player matched two flower tiles; a flower tile in the middle of the tile layout 108 with a flower tile also in the middle of the tile layout 108. The match counter 118 indicates three matches and the player is awarded 250 points to give him a total of 3400 points as shown by the score counter 112.

FIG. 14 shows the player having made an identical tile match. The player matched a tile on the left side of the tile layout 108 with an identical tile on the right side of the tile layout 108. The match counter 118 indicates four matches and the player is awarded 250 points to give him a total of 3650 points as shown by the score counter 112.

FIG. 15 shows the player having made an identical tile match. The player matched a tile on the left side of the tile layout 108 with an identical tile also on the left side of the tile layout 108. The match counter 118 indicates five matches (prior to being reset to zero matches) and the player is awarded 250 points and 1000 points for obtaining a SLINGO® to give him a total of 4900 points as shown by the score counter 112.

FIG. 16 shows the player having made an identical tile match. The player matched a tile on the left side of the tile layout 108 with an identical tile displayed by Mahjong tile 105B of game reel 104B. The match counter 118 indicates one match and the player is awarded 200 points to give him a total of 5100 points as shown by the score counter 112.

FIG. 17 shows the player having made an identical tile match. The player matched a tile in the middle of the tile layout 108 with an identical tile on the right side of the tile layout 108. The match counter 118 indicates two matches and the player is awarded 250 points to give him a total of 5350 points as shown by the score counter 112.

FIG. 18 shows the player having made an identical tile match. The player matched a tile in the middle of the tile layout 108 with an identical tile on the right side of the tile layout 108. The match counter 118 indicates three matches and the player is awarded 250 points to give him a total of 5600 points as shown by the score counter 112.

FIG. 19 shows the player having made a tile match of the same type. The player matched two seasons tiles; a seasons tile in the left side of the tile layout 108 with a seasons tile in the middle of the tile layout 108. The match counter 118 indicates four matches and the player is awarded 250 points to give him a total of 5850 points as shown by the score counter 112.

FIG. 20 shows the player having made an identical tile match. The player matched a tile in the middle of the tile layout 108 with an identical tile on the right side of the tile layout 108. The match counter 118 indicates five matches and the player is awarded 250 points and 2000 points for obtaining two SLINGOs back-to-back as indicated by window 300 (FIG. 21) to give him a total of 8100 points as shown by the score counter 112.

FIG. 22 shows the player having made an identical tile match. The player matched a tile on the right side of the tile layout 108 with an identical tile also on the right side of the tile layout 108. The match counter 118 indicates one match and the player is awarded 250 points to give him a total of 8350 points as shown by the score counter 112.

FIG. 23 shows the player having made an identical tile match. The player matched a tile in the middle of the tile layout 108 with an identical tile on the right side of the tile layout 108. The match counter 118 indicates two matches and the player is awarded 250 points to give him a total of 8600 points as shown by the score counter 112.

FIG. 24 shows the player having made an identical tile match. The player matched a tile in the middle of the tile layout 108 with an identical tile on the right side of the tile layout 108. The match counter 118 indicates three matches and the player is awarded 250 points to give him a total of 8850 points as shown by the score counter 112.

FIG. 25 shows the player having made an identical tile match. The player matched a tile on the left side of the tile layout 108 with an identical tile in the middle of the tile layout 108. The match counter 118 indicates four matches and the player is awarded 250 points to give him a total of 9100 points as shown by the score counter 112.

FIG. 26 shows the player having made an identical tile match. The player matched a tile on the left side of the tile layout 108 with an identical tile in the middle of the tile layout 108. The match counter 118 indicates five matches and the player is awarded 250 points and 3000 points for obtaining three SLINGOs back to back to back to give him a total of 12350 points as shown by the score counter 112. A message window 200 appears indicating the player obtained a SLINGO® back to back to back.

FIG. 27 shows the player having made an identical tile match. The player matched a tile on the left side of the tile layout 108 with an identical tile on the right side of the tile layout 108. The match counter 118 indicates one match and the player is awarded 250 points to give him a total of 12600 points as shown by the score counter 112.

FIG. 28 shows the player having made an identical tile match. The player matched a tile in the middle of the tile layout 108 with an identical tile on the right side of the tile layout 108. The match counter 118 indicates two matches and the player is awarded 250 points to give him a total of 12850 points as shown by the score counter 112.

FIG. 29 shows the player having made an identical tile match. The player matched a tile on the left side of the tile layout 108 with an identical tile displayed by graphical element 105D. The match counter 118 indicates three matches and the player is awarded 200 points to give him a total of 13050 points as shown by the score counter 112.

FIG. 30 shows the player having made an identical tile match. The player matched a tile on the right side of the tile layout 108 with an identical tile displayed by graphical element 105E. The match counter 118 indicates four matches and the player is awarded 200 points to give him a total of 13250 points as shown by the score counter 112. The player is also awarded a free spin for using all of the tiles displayed by game reels 104A-E.

FIG. 31 shows the graphical user interface 100 after the player selected the “SPIN” icon 106 in order for each of the game reels 104A-E to display a new graphical element 105. Since the player was awarded a free spin, the spin counter 116 continues to display 14 available spins.

FIG. 32 shows the player having selected the “HINT” icon 114 and the graphical user interface 100 shows two identical tiles capable of being matched highlighted. These tiles are on the left side of the tile layout 108 and denoted by reference numerals 154 and 156. The match counter 118 is reset to zero due to the hint request.

FIG. 33 shows the player having made an identical tile match. The player matched a tile on the left side of the tile layout 108 with an identical tile also on the left side of the tile layout 108. In particular, the player matched the two tiles which were highlighted following selection of the “HINT” icon 114. The match counter 118 indicates one match and the player is awarded 250 points to give him a total of 13500 points as shown by the score counter 112.

FIG. 34 shows the player having made an identical tile match. The player matched a tile in the middle of the tile layout 108 with an identical tile also in the middle of the tile layout 108. The match counter 118 indicates two matches and the player is awarded 250 points to give him a total of 13750 points as shown by the score counter 112.

FIG. 35 shows the player having made an identical tile match. The player matched a tile in the middle of the tile layout 108 with an identical tile displayed by graphical element 105E. The match counter 118 indicates three matches and the player is awarded 200 points to give him a total of 13950 points as shown by the score counter 112.

FIG. 36 shows the player having made an identical tile match. The player matched a tile in the middle of the tile layout 108 with an identical tile on the right side of the tile layout 108. The match counter 118 indicates four matches and the player is awarded 250 points to give him a total of 14200 points as shown by the score counter 112.

FIG. 37 shows the player having made an identical tile match. The player matched a tile on the right side of the tile layout 108 with an identical tile also on the right side of the tile layout 108. The match counter 118 indicates five matches and the player is awarded 250 points and 1000 points for obtaining a SLINGO® to give him a total of 15450 points as shown by the score counter 112. The match counter 118 is then reset to zero. The message window 200 appears indicating the player obtained a SLINGO®.

FIG. 38 shows the player having made an identical tile match. The player matched a tile on the left side of the tile layout 108 with an identical tile also on the left side of the tile layout 108. The match counter 118 indicates one match and the player is awarded 250 points to give him a total of 15700 points as shown by the score counter 112.

FIG. 39 shows the player having made an identical tile match. The player matched a tile on the left side of the tile layout 108 with an identical tile also on the left side of the tile layout 108. The match counter 118 indicates two matches and the player is awarded 250 points to give him a total of 15950 points as shown by the score counter 112.

FIG. 40 shows the player having made an identical tile match. The player matched a tile on the left side of the tile layout 108 with an identical tile on the right side of the tile layout 108. The match counter 118 indicates three matches and the player is awarded 250 points to give him a total of 16200 points as shown by the score counter 112.

FIG. 41 shows the player having made an identical tile match. The player matched a tile on the left side of the tile layout 108 with an identical tile displayed by graphical element 105B. The match counter 118 indicates four matches and the player is awarded 200 points to give him a total of 16400 points as shown by the score counter 112.

FIG. 42 shows the player having made an identical tile match. The player matched a tile on the left side of the tile layout 108 with an identical tile displayed by graphical element 105D. The match counter 118 indicates five matches and the player is awarded 200 points and 2000 points for obtaining two SLINGOs back-to-back to give him a total of 18600 points as shown by the score counter 112. A message window 300 indicates that the player achieved two SLINGOs back-to-back.

FIG. 43 shows the player having selected the “HINT” icon 114 and the graphical user interface 100 shows two identical tiles capable of being matched highlighted. One tile is in the middle of the tile layout 108 and denoted by reference numeral 158 and the other tile is on the right side of the tile layout 108 and denoted by reference numeral 160. The match counter 118 is reset to zero due to the hint request.

FIG. 44 shows the player having made a tile match of the same type. The player matched two flower tiles; a flower tile in the middle of the tile layout 108 with a flower tile in the right side of the tile layout 108. In particular, the player matched the two tiles which were highlighted following selection of the “HINT” icon 114. The match counter 118 indicates one match and the player is awarded 250 points to give him a total of 18850 points as shown by the score counter 112.

FIG. 45 shows the player having made an identical tile match. The player matched a tile on the left side of the tile layout 108 with an identical tile also on the left side of the tile layout 108. The match counter 118 indicates two matches and the player is awarded 250 points to give him a total of 19100 points as shown by the score counter 112.

FIG. 46 shows the player having made an identical tile match. The player matched a tile on the left side of the tile layout 108 with an identical tile also on the left side of the tile layout 108. The match counter 118 indicates three matches and the player is awarded 250 points to give him a total of 19350 points as shown by the score counter 112.

FIG. 47 shows the player having made an identical tile match. The player matched a tile on the left side of the tile layout 108 with an identical tile on the right side of the tile layout 108. The match counter 118 indicates four matches and the player is awarded 250 points to give him a total of 19600 points as shown by the score counter 112.

FIG. 48 shows the player having made an identical tile match. The player matched a tile on the left side of the tile layout 108 with an identical tile on the right side of the tile layout 108. The match counter 118 indicates five matches and the player is awarded 250 points and 1000 points for obtaining a SLINGO® to give him a total of 20850 points as shown by the score counter 112. The message window 200 appears indicating the player obtained a SLINGO®.

FIG. 49 shows the player having made an identical tile match. The player matched a tile on the left side of the tile layout 108 with an identical tile also on the left side of the tile layout 108. The match counter 118 indicates one match and the player is awarded 250 points to give him a total of 21100 points as shown by the score counter 112.

FIG. 50 shows the player having made an identical tile match. The player matched a tile in the middle of the tile layout 108 with an identical tile on the right side of the tile layout 108. The match counter 118 indicates two matches and the player is awarded 250 points to give him a total of 21350 points as shown by the score counter 112.

FIG. 51 shows the player having made an identical tile match. The player matched a tile on the right side of the tile layout 108 with an identical tile displayed by graphical element 105C. The match counter 118 indicates three matches and the player is awarded 200 points to give him a total of 21550 points as shown by the score counter 112.

FIG. 52 shows the player having selected the “HINT” icon 114 and the graphical user interface 100 displays a message stating “You need to take another spin,” since the graphical user interface 100 does not display two tiles that can be matched. Since the player selected the “HINT” icon 114, the number of matches displayed by the match counter 118 is reset to zero.

FIG. 53 shows the graphical user interface 100 after the player selected the “SPIN” icon 106 in order for each of the game reels 104A-E to display a new graphical element 105. The spin counter 116 displays 13 available spins.

FIG. 54 shows the player having made an identical tile match. The player matched a tile on the left side of the tile layout 108 with an identical tile displayed by graphical element 105D. The match counter 118 indicates one match and the player is awarded 200 points to give him a total of 21750 points as shown by the score counter 112.

FIG. 55 shows the player having made an identical tile match. The player matched a tile on the right side of the tile layout 108 with an identical tile displayed by graphical element 105C. The match counter 118 indicates two matches and the player is awarded 200 points to give him a total of 21950 points as shown by the score counter 112.

FIG. 56 shows the player having made an identical tile match. The player matched a tile on the right side of the tile layout 108 with an identical tile displayed by graphical element 105A. The match counter 118 indicates three matches and the player is awarded 200 points to give him a total of 22150 points as shown by the score counter 112.

FIG. 57 shows the player having selected the “HINT” icon 114 and the graphical user interface 100 displays a message stating “You need to take another spin,” since the graphical user interface 100 does not display two tiles that can be matched. Since the player selected the “HINT” icon 114, the number of matches displayed by the match counter 118 is reset to zero.

FIG. 58 shows the graphical user interface 100 after the player selected the “SPIN” icon 106 in order for each of the game reels 104A-E to display a new graphical element 105. The spin counter 116 displays 12 available spins.

FIG. 59 shows the player having made an identical tile match. The player matched a tile in the middle of the tile layout 108 with an identical tile displayed by graphical element 105B. The match counter 118 indicates one match and the player is awarded 200 points to give him a total of 22350 points as shown by the score counter 112.

FIG. 60 shows the player having made an identical tile match. The player matched a tile in the middle of the tile layout 108 with an identical tile displayed by graphical element 105D. The match counter 118 indicates two matches and the player is awarded 200 points to give him a total of 22550 points as shown by the score counter 112.

FIG. 61 shows the graphical user interface 100 after the player selected the “SPIN” icon 106 in order for each of the game reels 104A-E to display a new graphical element 105. The spin counter 116 displays II available spins.

FIG. 62 shows the player having made an identical tile match. The player matched a tile on the right side of the tile layout 108 with an identical tile displayed by graphical element 105E. The match counter 118 indicates one match and the player is awarded 200 points to give him a total of 22750 points as shown by the score counter 112.

FIG. 63 shows the player having made an identical tile match. The player matched a tile in the middle of the tile layout 108 with an identical tile displayed by graphical element 105B. The match counter 118 indicates two matches and the player is awarded 200 points to give him a total of 22950 points as shown by the score counter 112.

FIG. 64 shows the player having made an identical tile match. The player matched a tile on the right side of the tile layout 108 with an identical tile displayed by graphical element 105A. The match counter 118 indicates three matches and the player is awarded 200 points to give him a total of 23150 points as shown by the score counter 112.

FIG. 65 shows the player having selected the “HINT” icon 114 and the graphical user interface 100 displays a message stating “You need to take another spin,” since the graphical user interface 100 does not display two tiles that can be matched. Since the player selected the “HINT” icon 114, the number of matches displayed by the match counter 118 is reset to zero.

FIG. 66 shows the graphical user interface 100 after the player selected the “SPIN” icon 106 in order for each of the game reels 104A-E to display a new graphical element 105. The spin counter 116 displays 10 available spins.

FIG. 67 shows the player having selected the “HINT” icon 114 and the graphical user interface 100 displays a message stating “You need to take another spin,” since the graphical user interface 100 does not display two tiles that can be matched.

FIG. 68 shows the graphical user interface 100 after the player selected the “SPIN” icon 106 in order for each of the game reels 104A-E to display a new graphical element 105. The spin counter 116 displays 9 available spins.

FIG. 69 shows the player having made an identical tile match. The player matched a tile in the middle of the tile layout 108 with an identical tile displayed by graphical element 105E. The match counter 118 indicates one match and the player is awarded 200 points to give him a total of 23350 points as shown by the score counter 112.

FIG. 70 shows the player having made an identical tile match. The player matched a tile on the left side of the tile layout 108 with an identical tile displayed by graphical element 105D. The match counter 118 indicates two matches and the player is awarded 200 points to give him a total of 23550 points as shown by the score counter 112.

FIG. 71 shows the player having made an identical tile match. The player matched a tile on the right side of the tile layout 108 with an identical tile displayed by graphical element 105A. The match counter 118 indicates three matches and the player is awarded 200 points to give him a total of 23750 points as shown by the score counter 112.

FIG. 72 shows the graphical user interface 100 after the player selected the “SPIN” icon 106 in order for each of the game reels 104A-E to display a new graphical element 105. The spin counter 116 displays 8 available spins and the match counter 118 is reset to zero.

FIG. 73 shows the player having made an identical tile match. The player matched a tile on the left side of the tile layout 108 with an identical tile displayed by graphical element 105E. The match counter 118 indicates one match and the player is awarded 200 points to give him a total of 23950 points as shown by the score counter 112.

FIG. 74 shows the player having made an identical tile match. The player matched a tile on the left side of the tile layout 108 with an identical tile in the middle of the tile layout 108. The match counter 118 indicates two matches and the player is awarded 250 points to give him a total of 24200 points as shown by the score counter 112.

FIG. 75 shows the player having made an identical tile match. The player matched a tile on the left side of the tile layout 108 with an identical tile in the middle of the tile layout 108. The match counter 118 indicates three matches and the player is awarded 250 points to give him a total of 24450 points as shown by the score counter 112.

FIG. 76 shows the graphical user interface 100 after the player selected the “SPIN” icon 106 in order for each of the game reels 104A-E to display a new graphical element 105. The spin counter 116 displays 7 available spins and the match counter 118 is reset to zero.

FIG. 77 shows the player having made an identical tile match. The player matched a tile in the middle of the tile layout 108 with an identical tile displayed by graphical element 105B. The match counter 118 indicates one match and the player is awarded 200 points to give him a total of 24650 points as shown by the score counter 112.

FIG. 78 shows the player having made an identical tile match. The player matched a tile in the middle of the tile layout 108 with an identical tile displayed by graphical element 105A. The match counter 118 indicates two matches and the player is awarded 200 points to give him a total of 24850 points as shown by the score counter 112.

FIG. 79 shows the player having made an identical tile match. The player matched a tile in the middle of the tile layout 108 with an identical tile displayed by graphical element 105D. The match counter 118 indicates three matches and the player is awarded 200 points to give him a total of 25050 points as shown by the score counter 112.

FIG. 80 shows the player having selected the “HINT” icon 114 and the graphical user interface 100 displays a message stating “You need to take another spin,” since the graphical user interface 100 does not display two tiles that can be matched. The match counter 118 is reset to zero.

FIG. 81 shows the graphical user interface 100 after the player selected the “SPIN” icon 106 in order for each of the game reels 104A-E to display a new graphical element 105. The spin counter 116 displays 6 available spins.

FIG. 82 shows the player having made an identical tile match. The player matched a tile on the right side of the tile layout 108 with an identical tile displayed by graphical element 105B. The match counter 118 indicates one match and the player is awarded 200 points to give him a total of 25250 points as shown by the score counter 112.

FIG. 83 shows the graphical user interface 100 after the player selected the “SPIN” icon 106 in order for each of the game reels 104A-E to display a new graphical element 105. The spin counter 116 displays 5 available spins and the match counter 118 is reset to zero.

FIG. 84 shows the player having made an identical tile match. The player matched a tile in the middle of the tile layout 108 with an identical tile displayed by graphical element 105A. The match counter 118 indicates one match and the player is awarded 200 points to give him a total of 25450 points as shown by the score counter 112.

FIG. 85 shows the graphical user interface 100 after the player selected the “SPIN” icon 106 in order for each of the game reels 104A-E to display a new graphical element 105. The spin counter 116 displays 4 available spins. FIG. 86 shows the graphical user interface 100 after the player selected the “PAUSE” icon 120.

FIG. 87 shows the graphical user interface 100 after the player selected the “SPIN” icon 106 in order for each of the game reels 104A-E to display a new graphical element 105. The spin counter 116 displays 3 available spins.

FIG. 88 shows the player having made an identical tile match. The player matched a tile in the middle of the tile layout 108 with an identical tile displayed by graphical element 105E. The match counter 118 indicates one match and the player is awarded 200 points to give him a total of 25650 points as shown by the score counter 112.

FIG. 89 shows the player having made an identical tile match. The player matched a tile in the middle of the tile layout 108 with an identical tile displayed by graphical element 105A. The match counter 118 indicates two matches and the player is awarded 200 points to give him a total of 25850 points as shown by the score counter 112.

FIG. 90 shows the player having made an identical tile match. The player matched a tile in the middle of the tile layout 108 with an identical tile displayed by graphical element 105B. The match counter 118 indicates three matches and the player is awarded 200 points to give him a total of 26050 points as shown by the score counter 112.

FIG. 91 shows the graphical user interface 100 after the player selected the “SPIN” icon 106 in order for each of the game reels 104A-E to display a new graphical element 105. The spin counter 116 displays 2 available spins and the match counter 118 is reset to zero.

FIG. 92 shows the graphical user interface 100 after the player selected the “SPIN” icon 106 in order for each of the game reels 104A-E to display a new graphical element 105. The spin counter 116 displays 1 available spin.

FIG. 93 shows the player having made an identical tile match. The player matched a tile in the middle of the tile layout 108 with an identical tile displayed by graphical element 105C. The match counter 118 indicates one match and the player is awarded 200 points to give him a total of 26250 points as shown by the score counter 112.

FIG. 94 shows the player having made an identical tile match. The player matched a tile on the right side of the tile layout 108 with an identical tile displayed by graphical element 105E. The match counter 118 indicates two matches and the player is awarded 200 points to give him a total of 26450 points as shown by the score counter 112.

FIG. 95 shows the player having made an identical tile match. The player matched a tile on the right side of the tile layout 108 with an identical tile displayed by graphical element 105B. The match counter 118 indicates three matches and the player is awarded 200 points to give him a total of 26650 points as shown by the score counter 112.

FIG. 96 shows the graphical user interface 100 after the player selected the “SPIN” icon 106 in order for each of the game reels 104A-E to display a new graphical element 105. However, since there are three tiles left to match, only two graphical elements are displayed by game reels 104A and 104B. The spin counter 116 displays 0 available spins. Alternatively, each game reel 104A-104E displays a new graphical element instead of games reels 104A and 104B only.

FIG. 97 shows the player having made an identical tile match after having requested a hint by selecting the “HINT” icon 114. The graphical user interface 100 highlighted the two tiles identified by the letter “S” (not shown). The player selected these two tiles to match. Accordingly, the match counter 118 indicates one match and the player is awarded 250 points to give him a total of 26900 points as shown by the score counter 112.

FIG. 98 shows the player having made an identical tile match. The player matched a tile on the right side of the tile layout 108 with an identical tile displayed by graphical element 105B. The match counter 118 indicates two matches and the player is awarded 200 points to give him a total of 27100 points as shown by the score counter 112.

FIG. 99 shows the player having made an identical tile match and having cleared or matched all the tiles from the tile layout 108. The player matched a tile on the right side of the tile layout 108 with an identical tile displayed by graphical element 105A. The match counter 118 indicates three matches and the player is awarded 200. The player is also awarded 10000 points as a completion bonus, plus a time bonus of 8400 for a total of 45700 points as shown by the score counter 112. The graphical user interface also displays the number of SLINGOs obtained during game play, the number of tile matches during game play and the amount of time used.

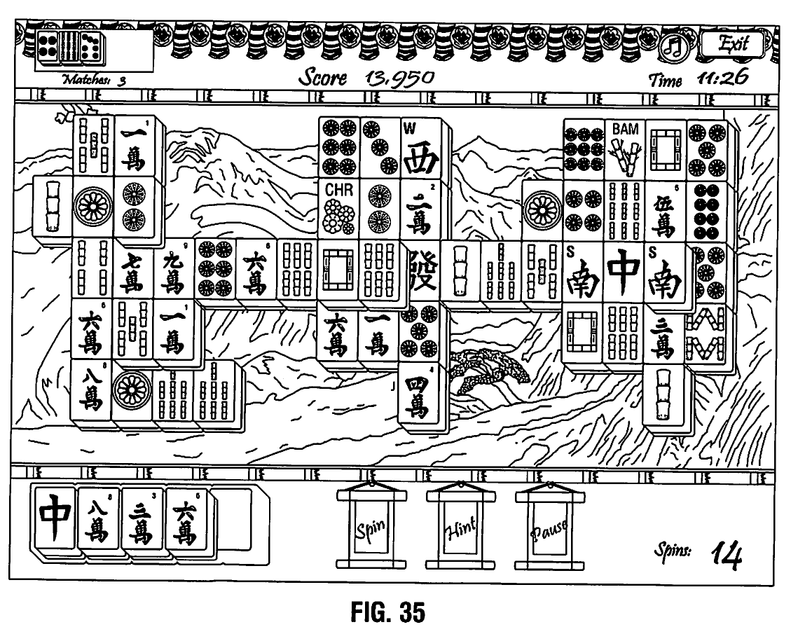

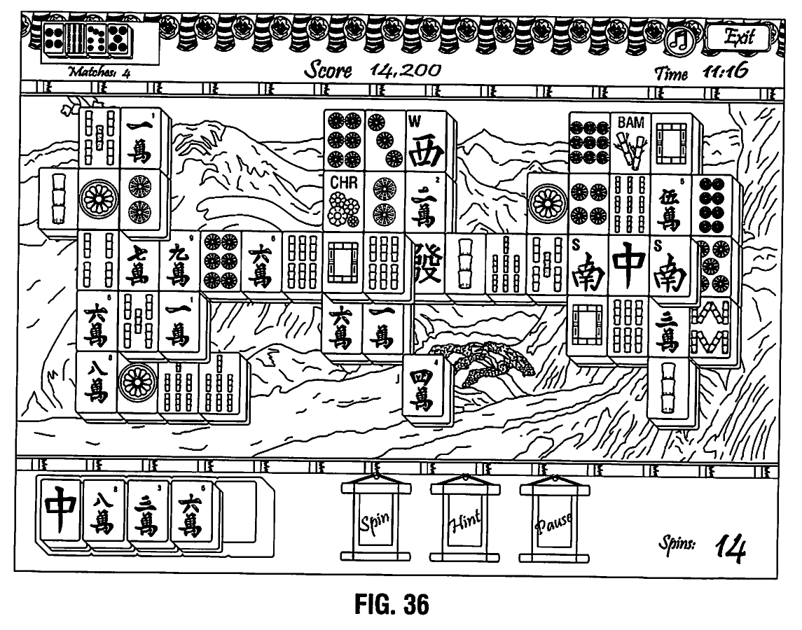

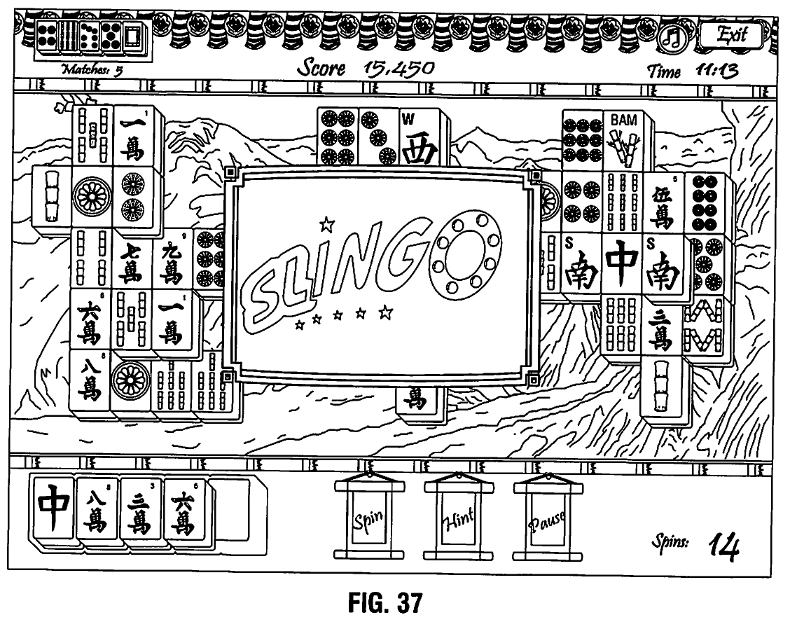

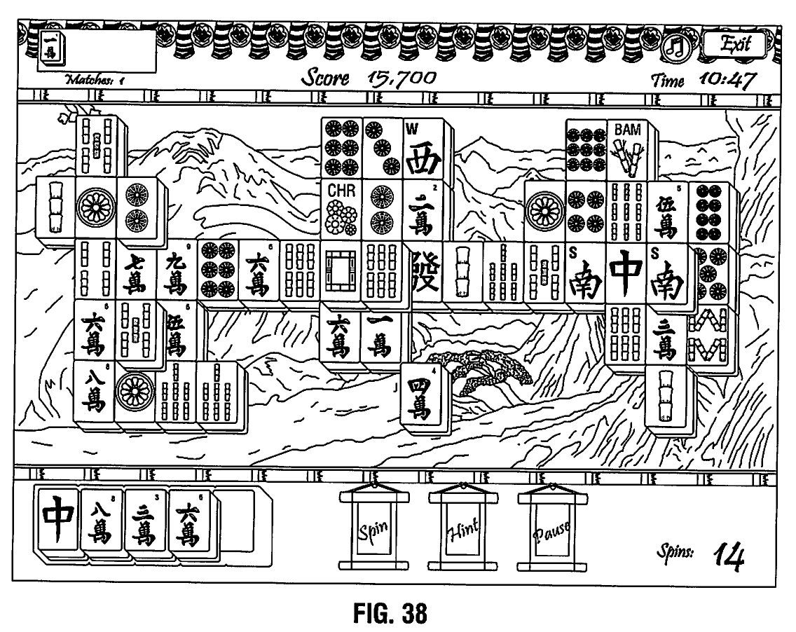

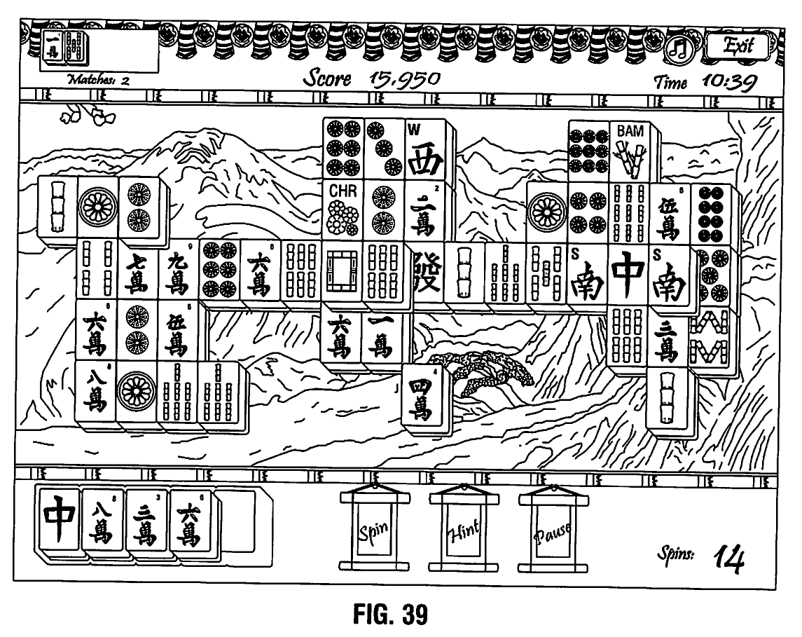

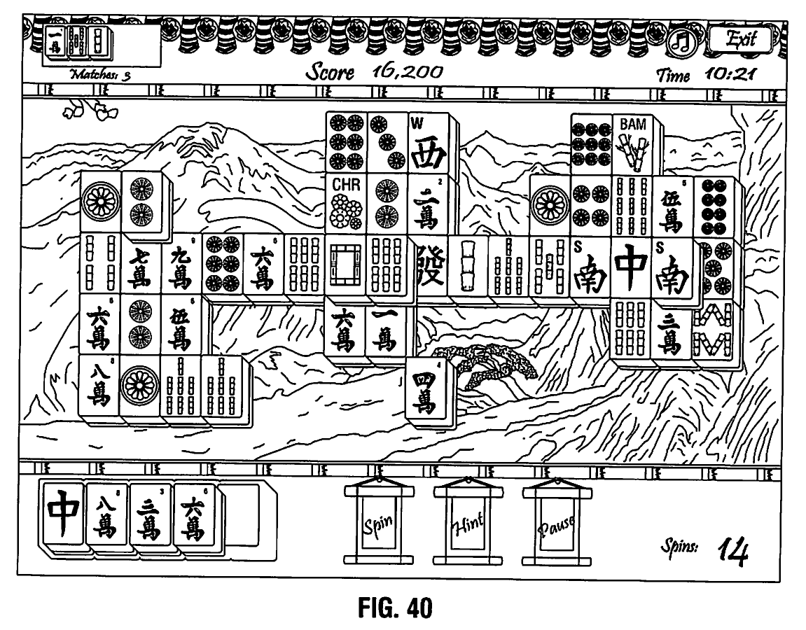

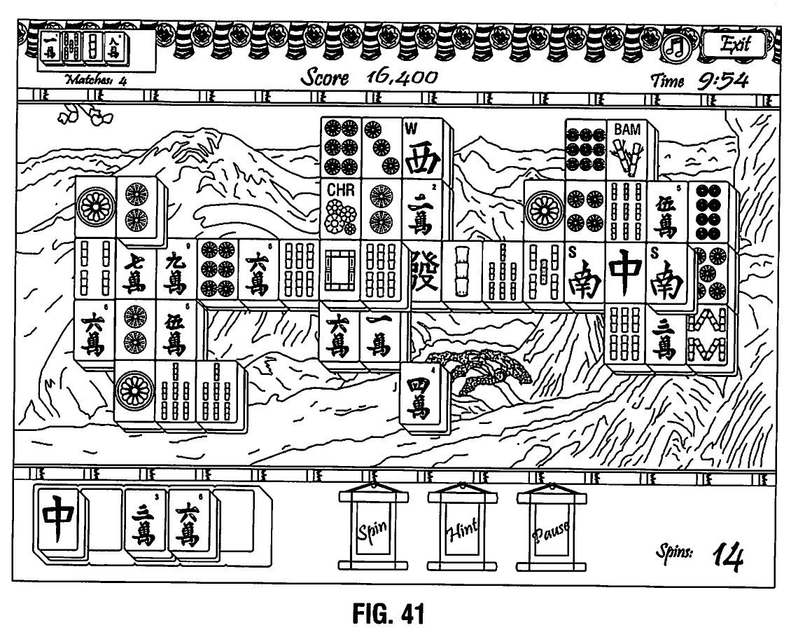

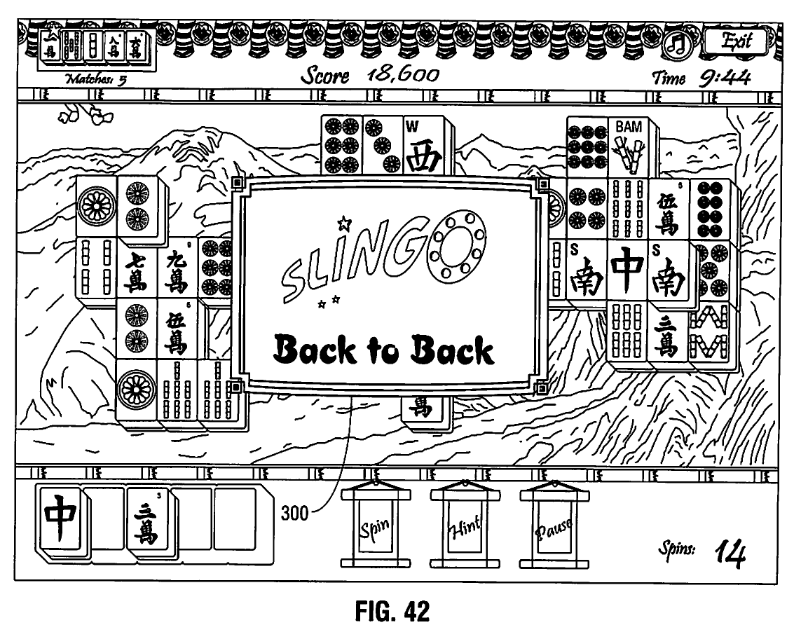

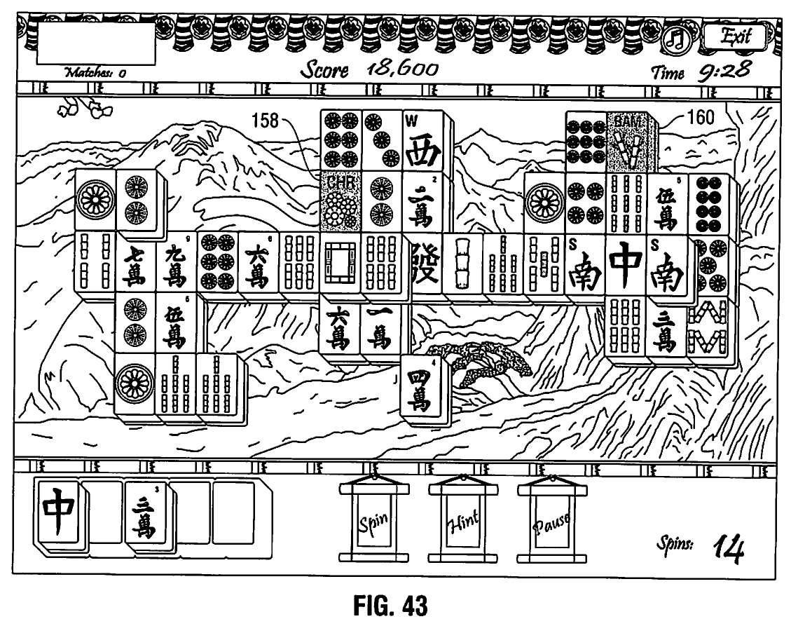

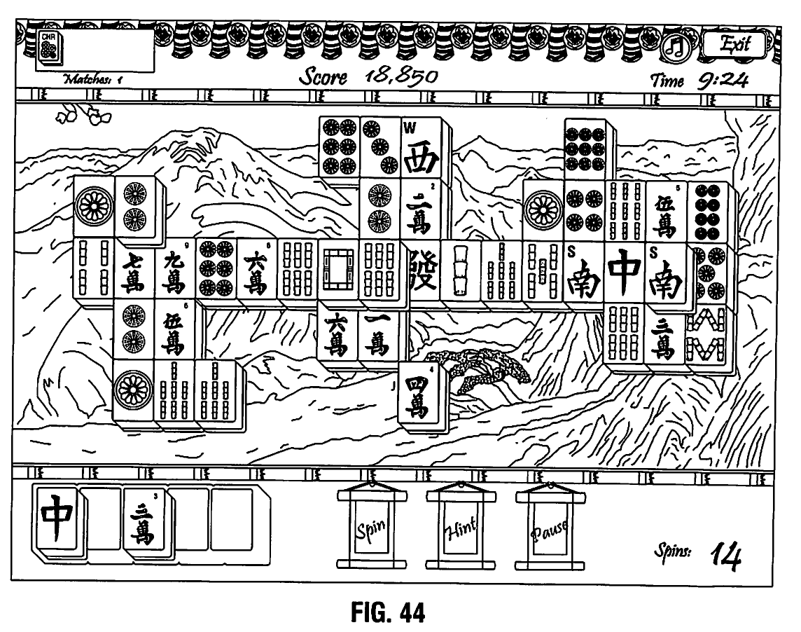

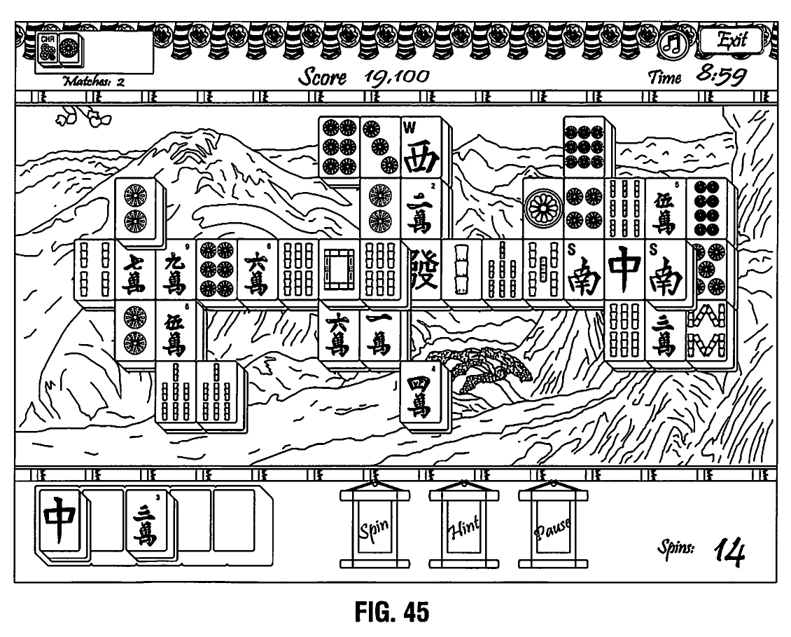

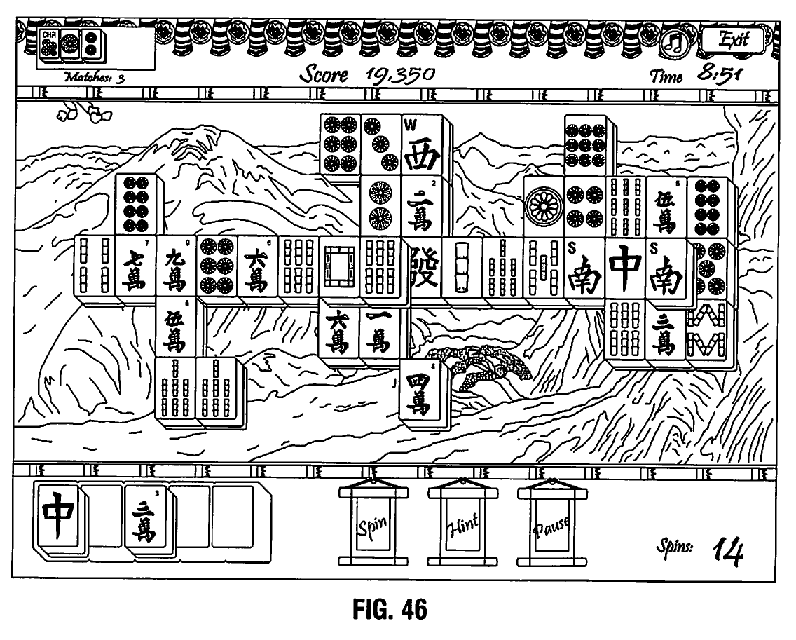

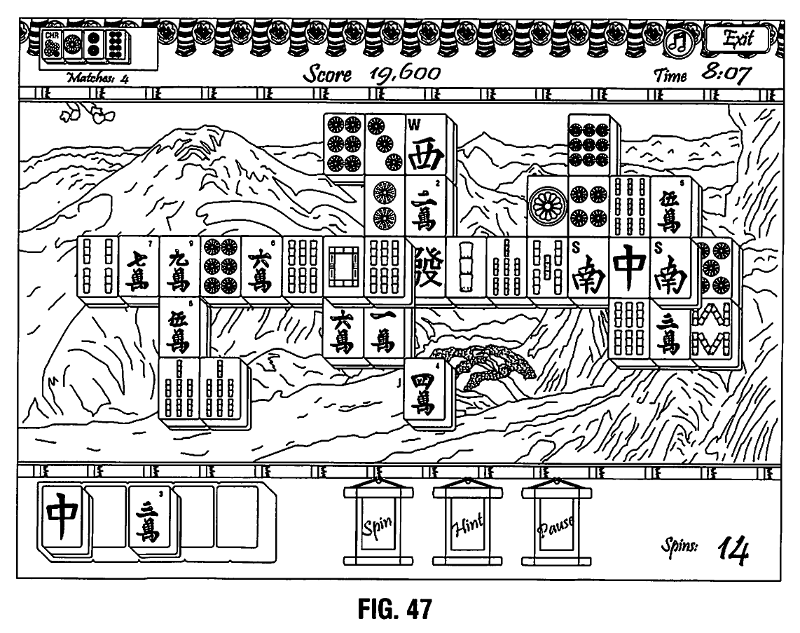

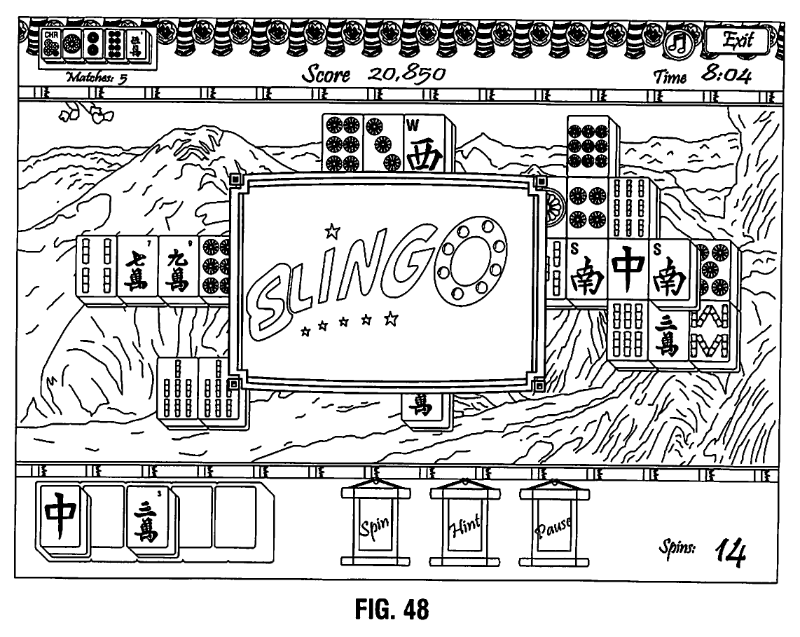

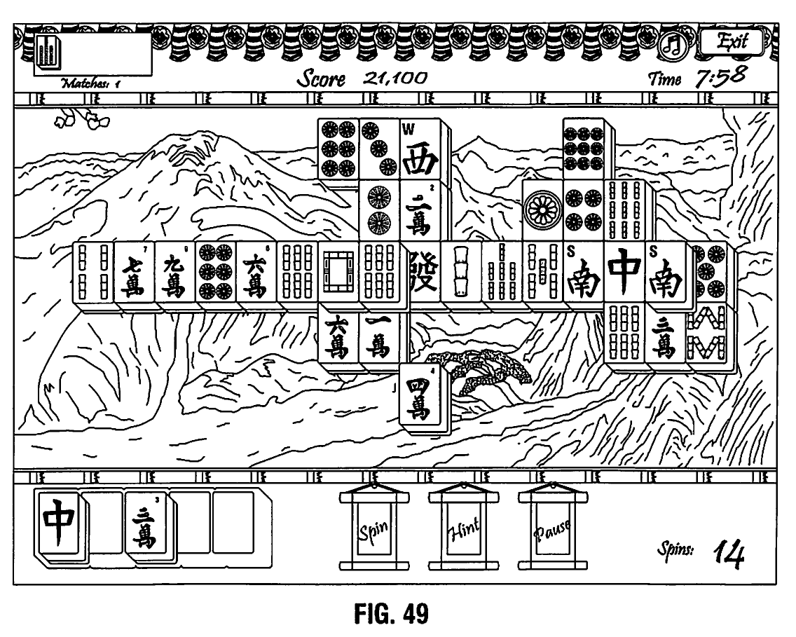

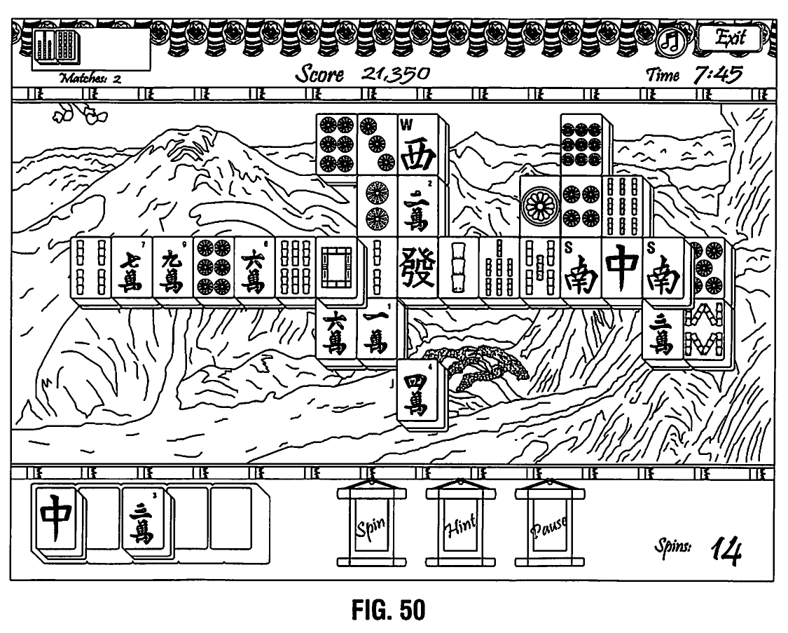

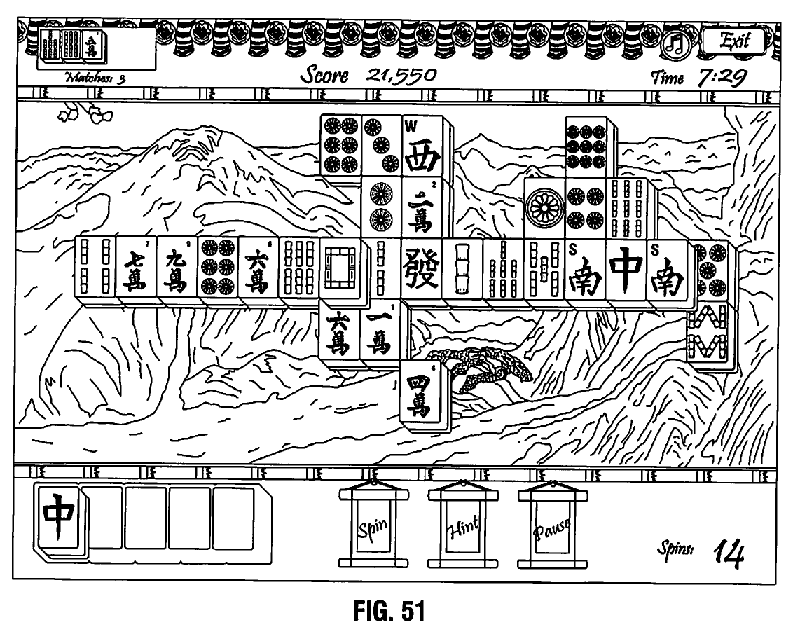

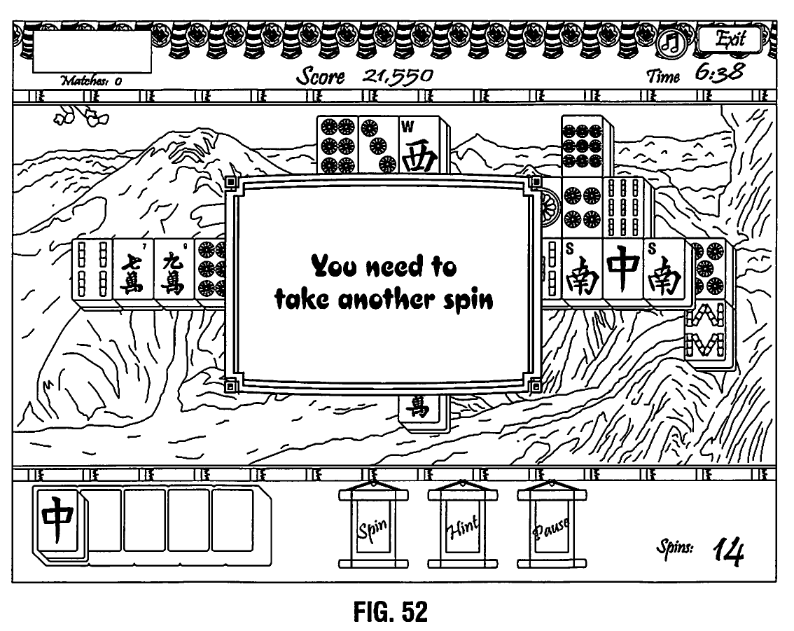

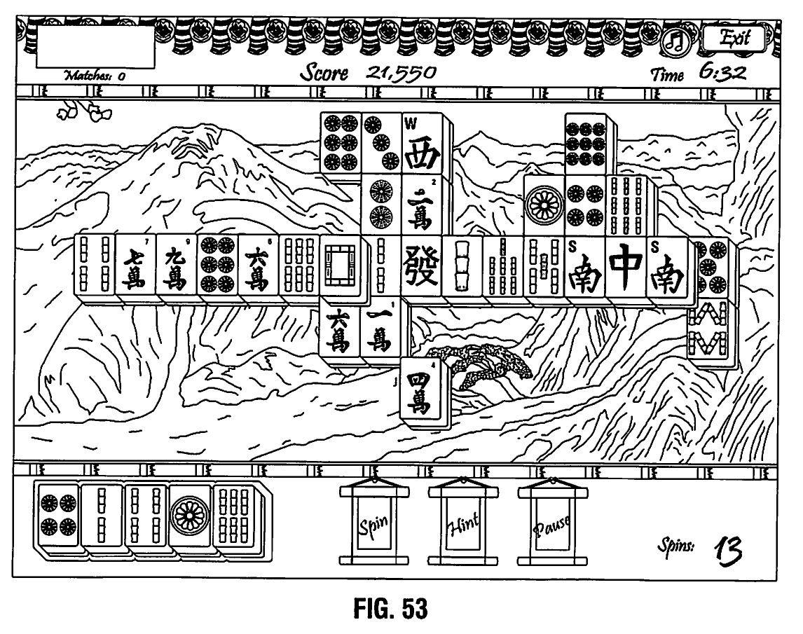

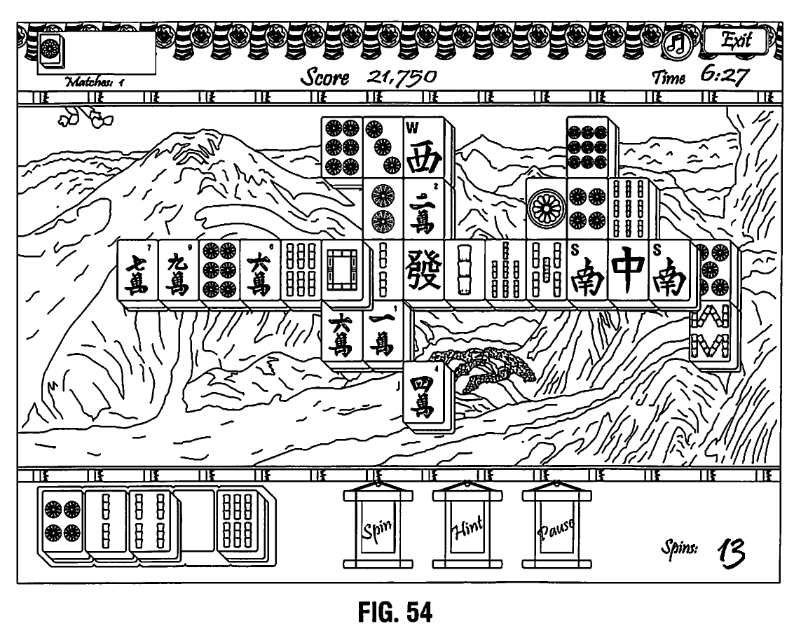

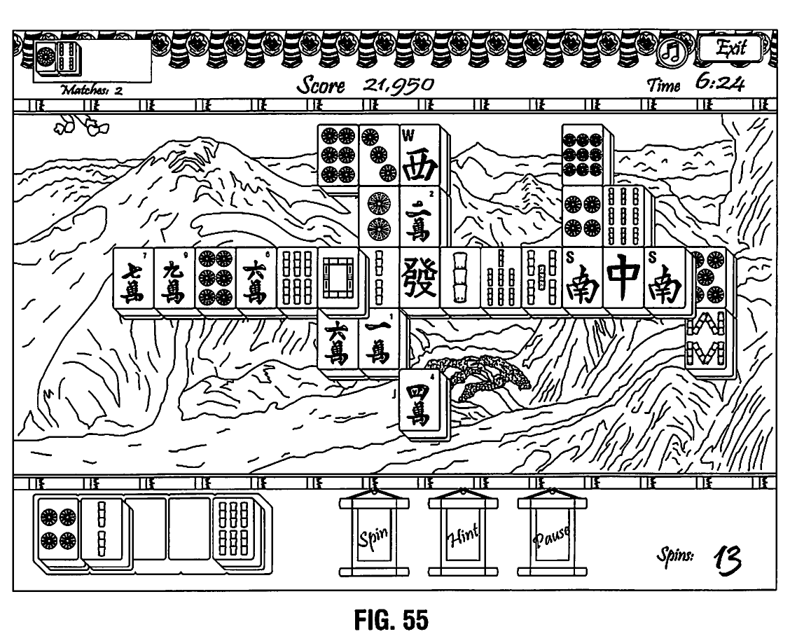

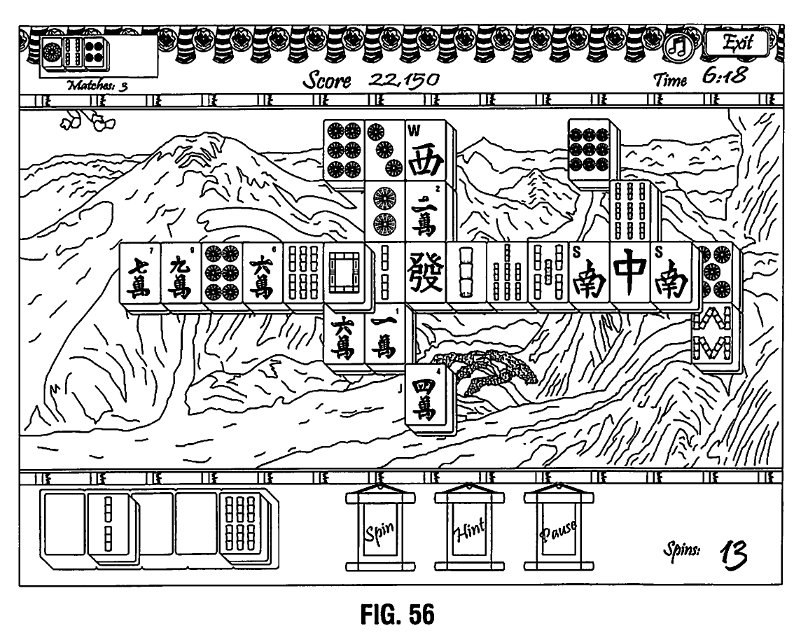

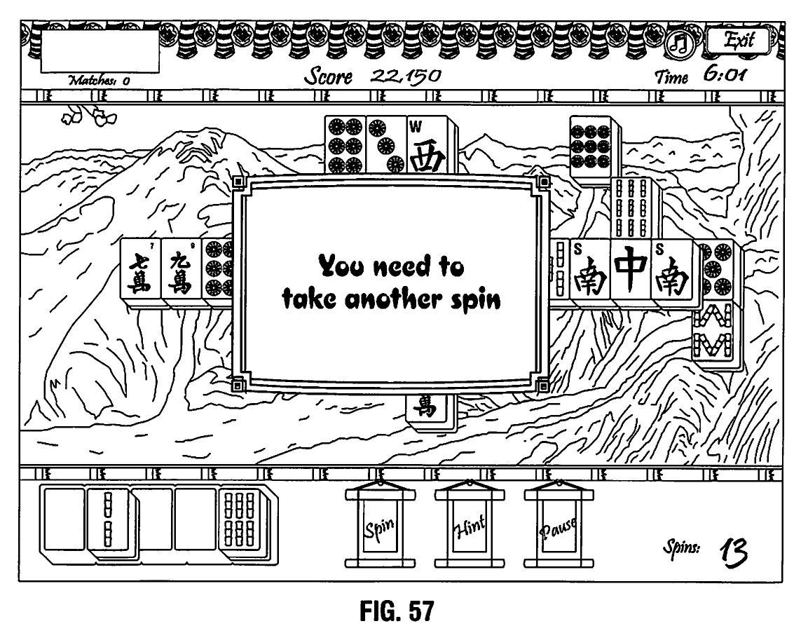

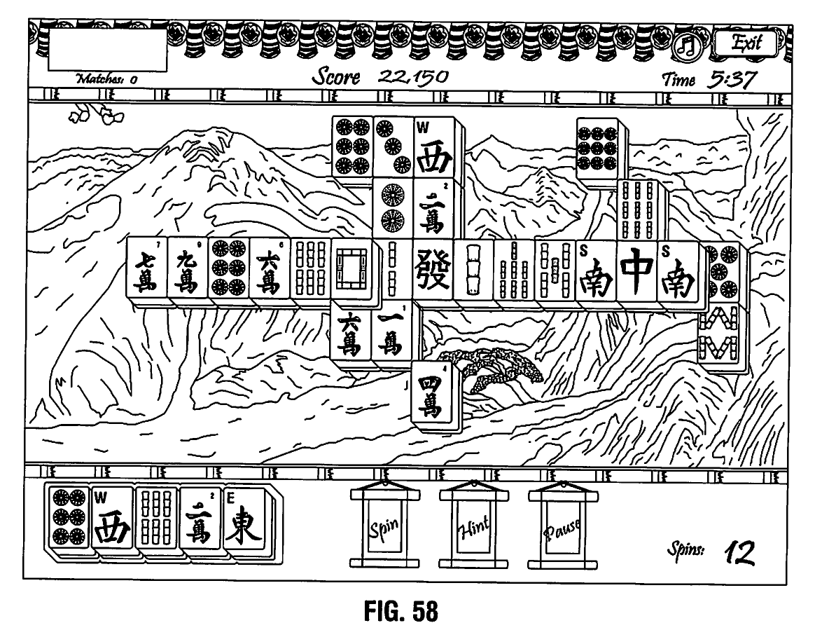

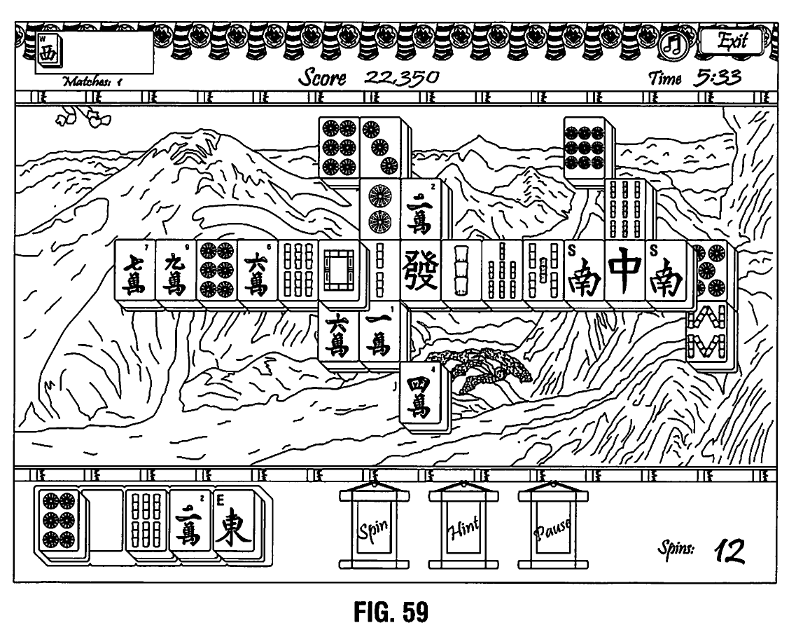

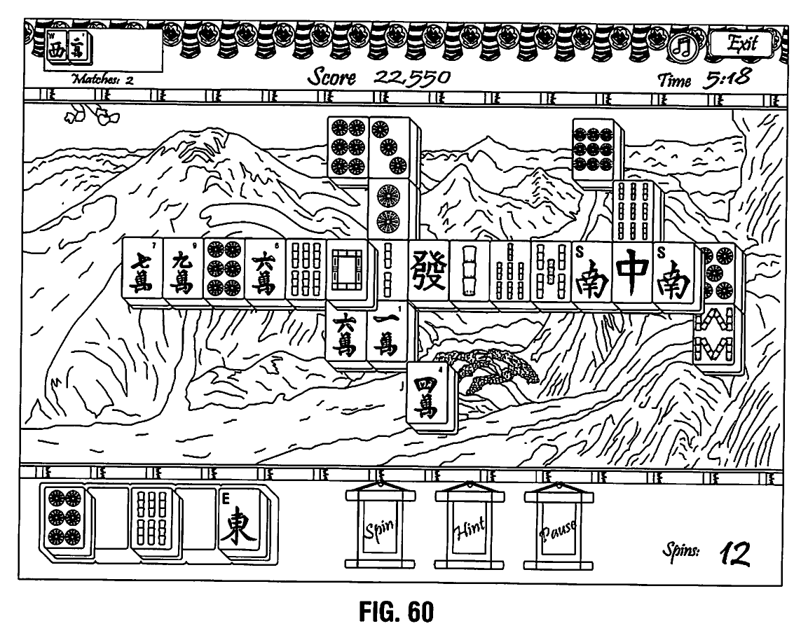

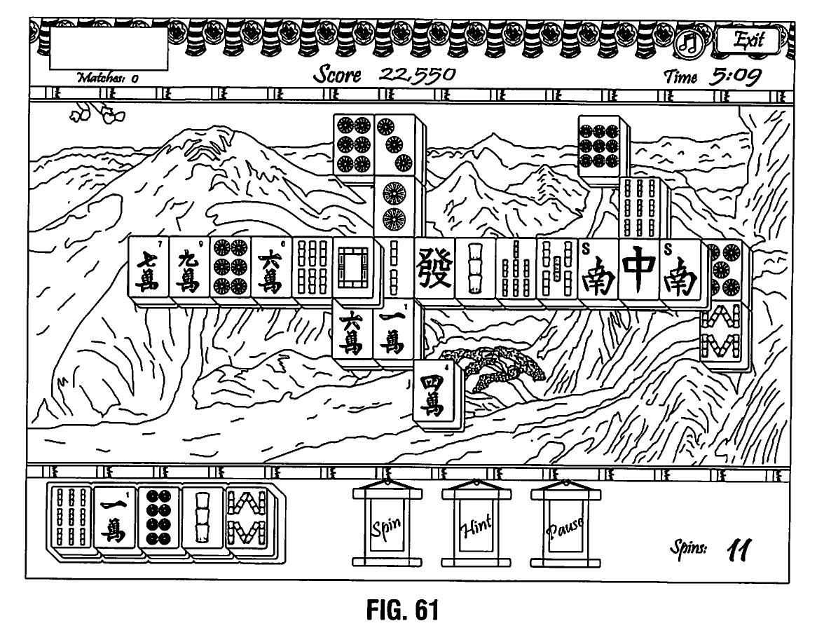

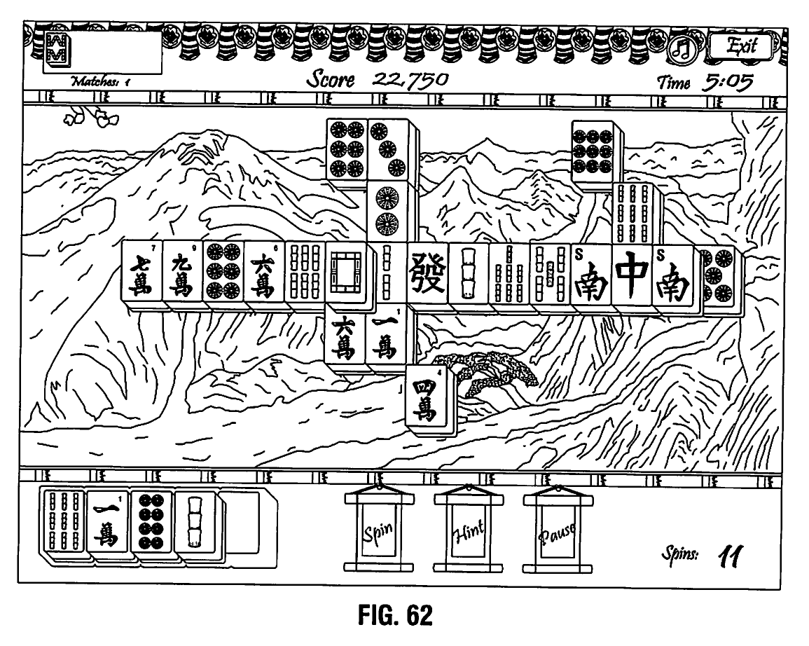

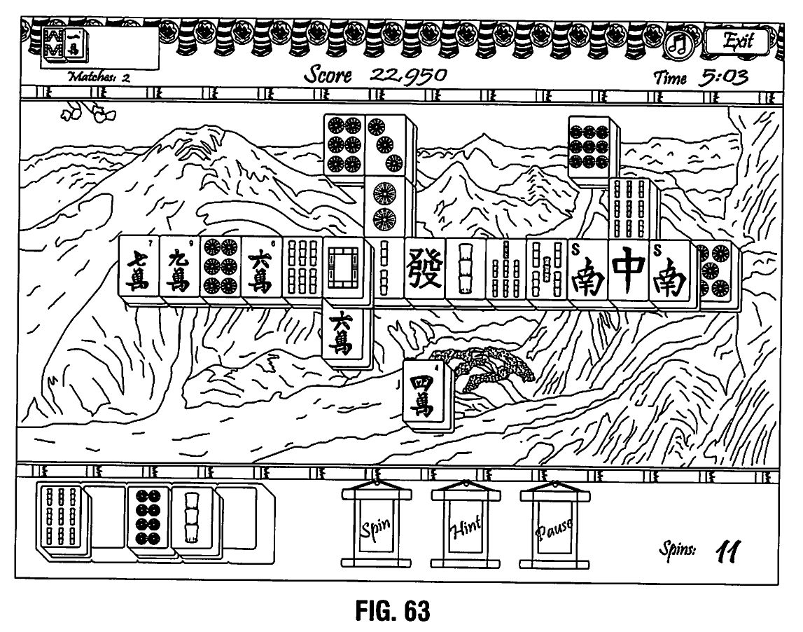

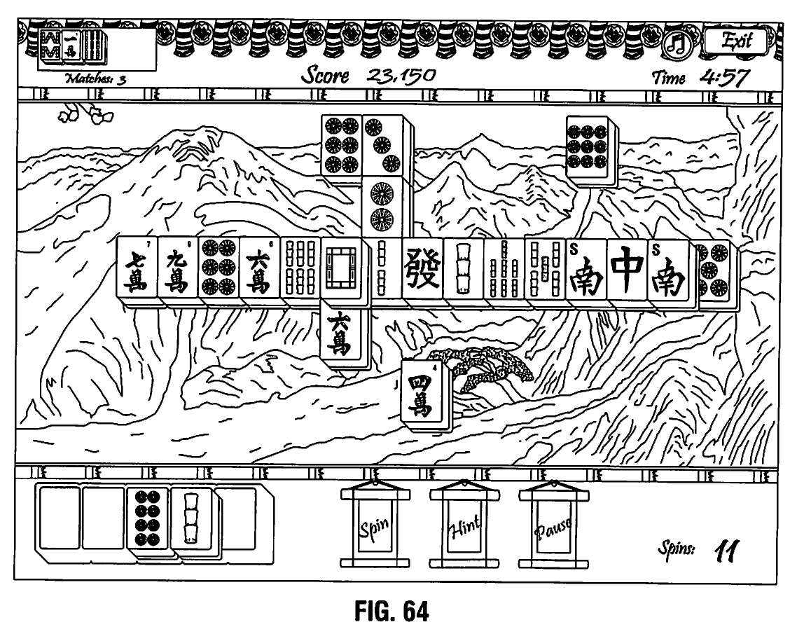

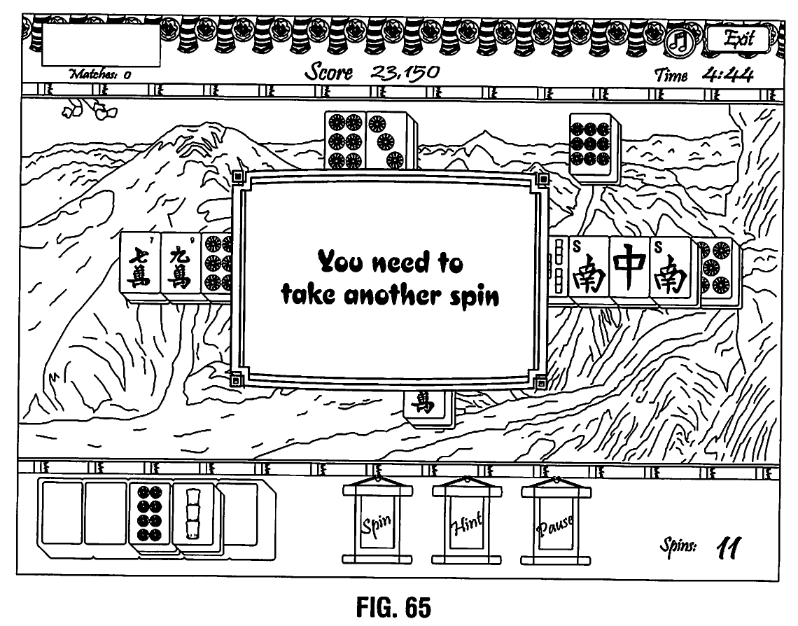

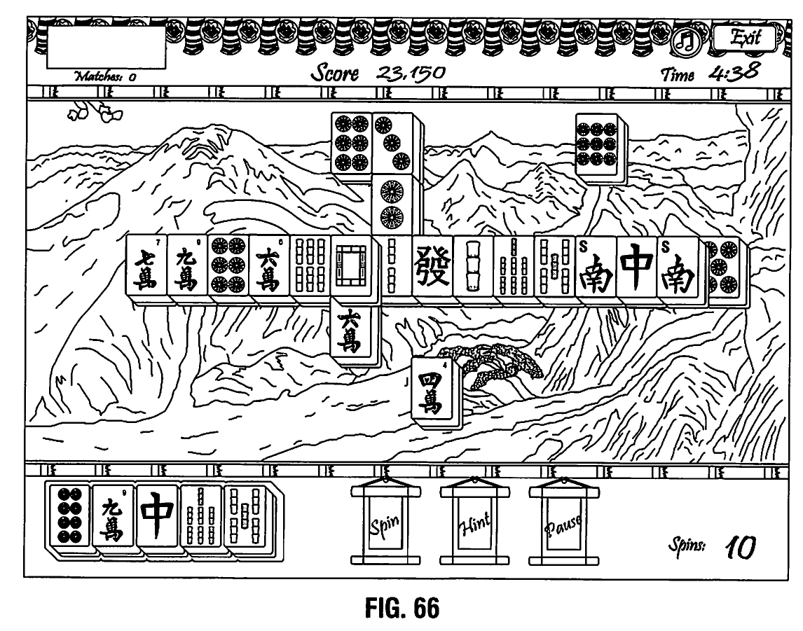

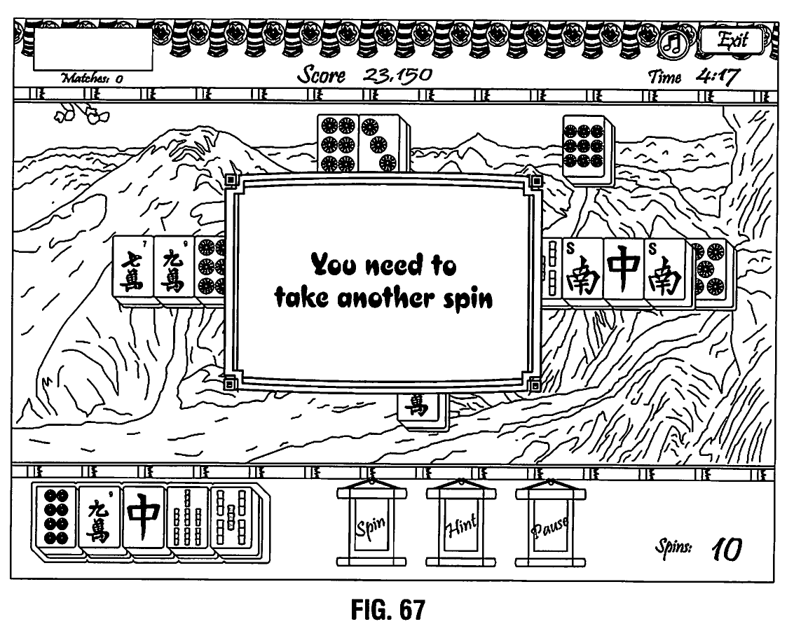

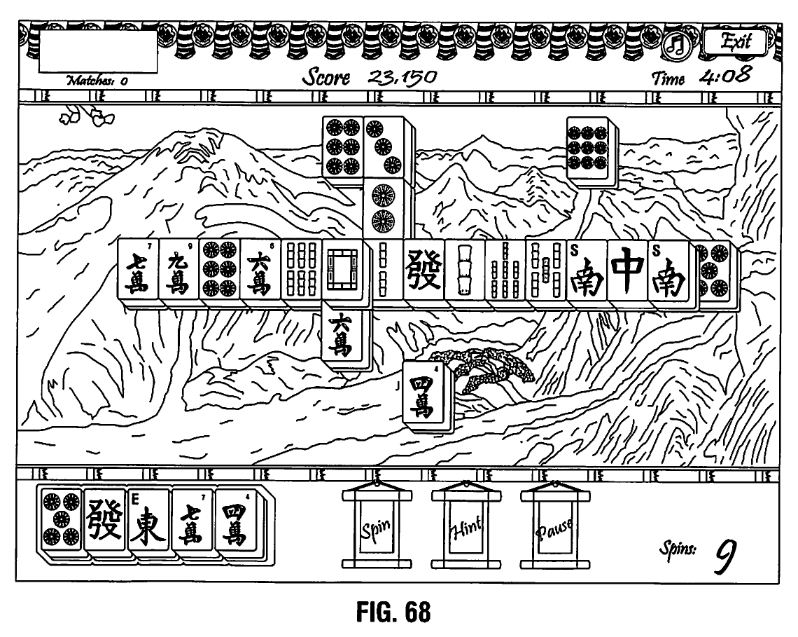

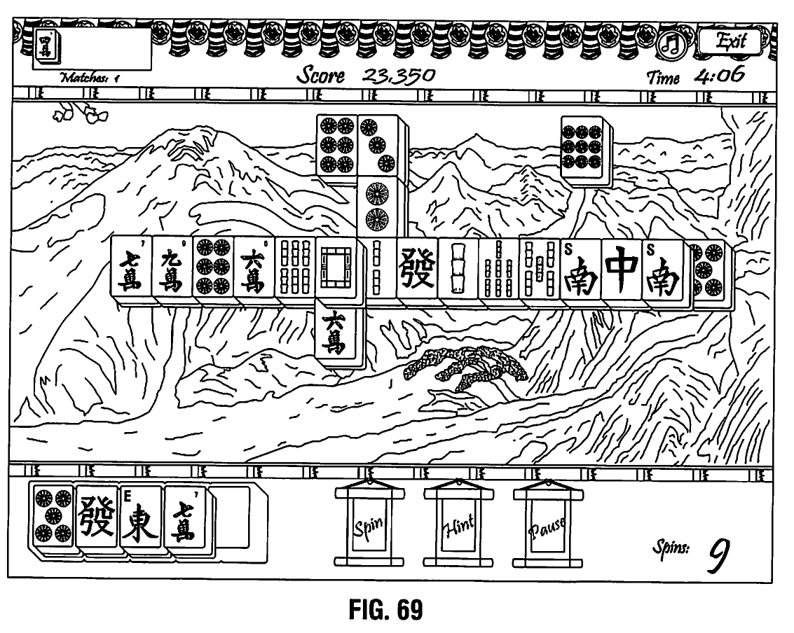

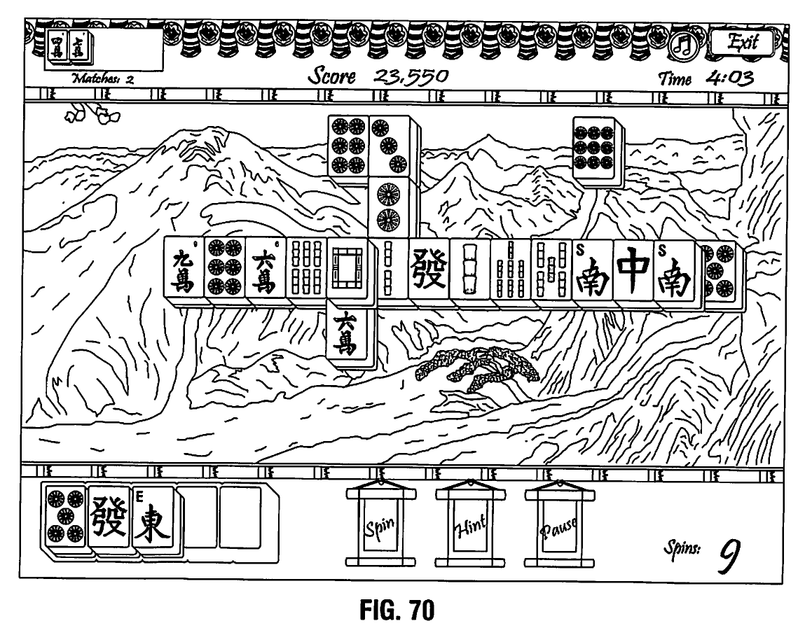

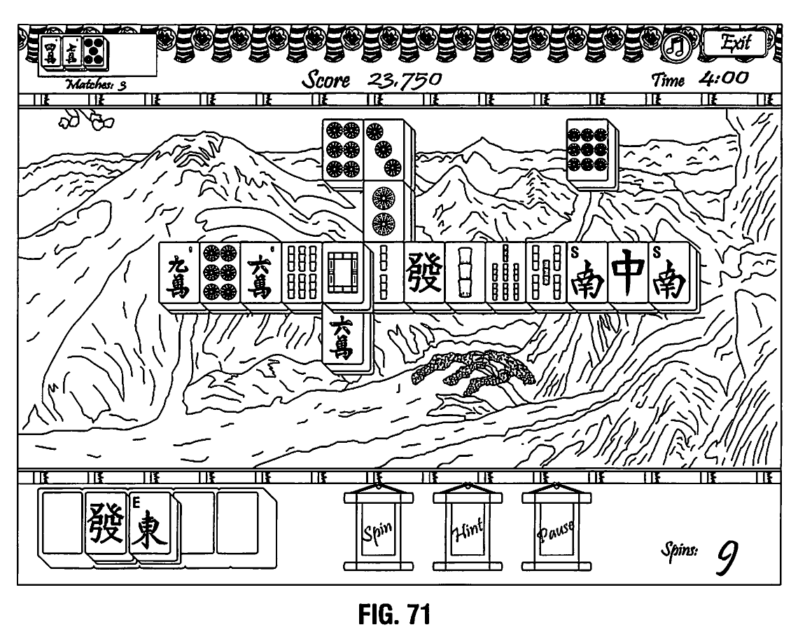

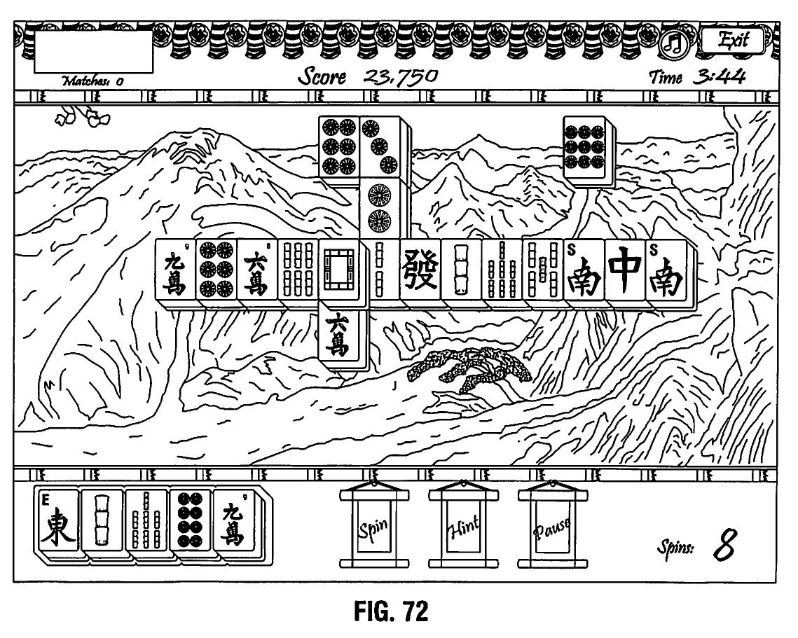

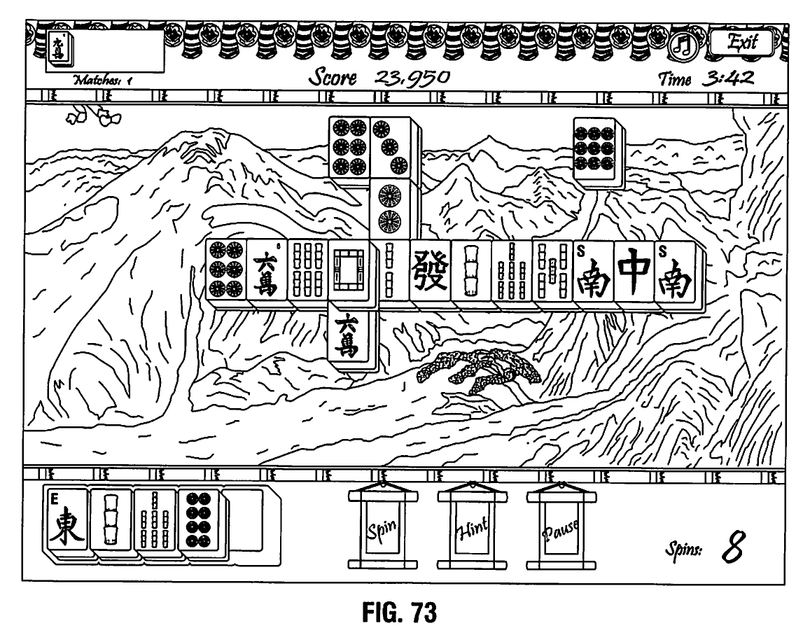

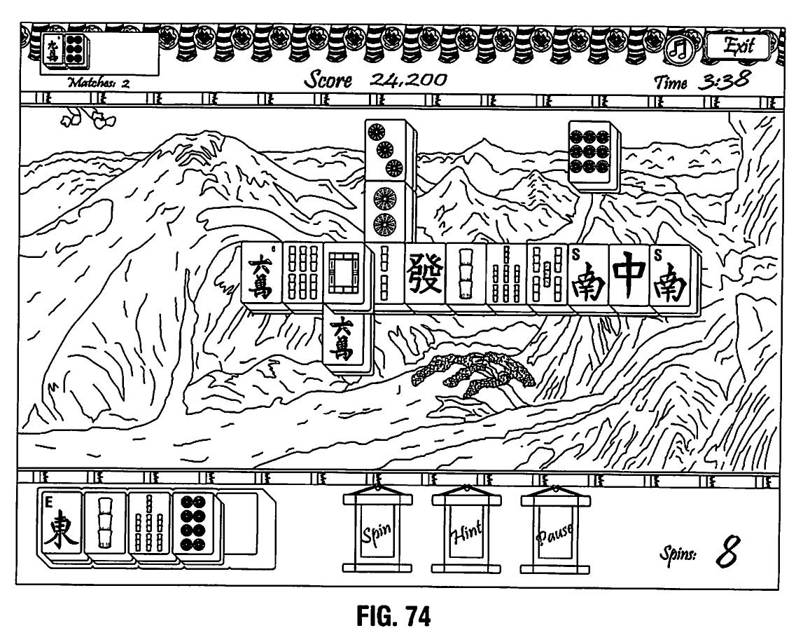

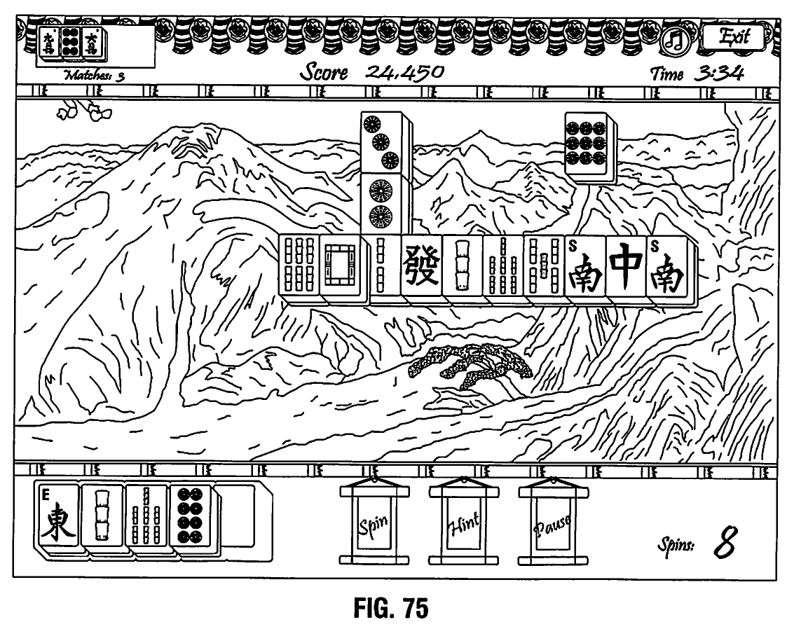

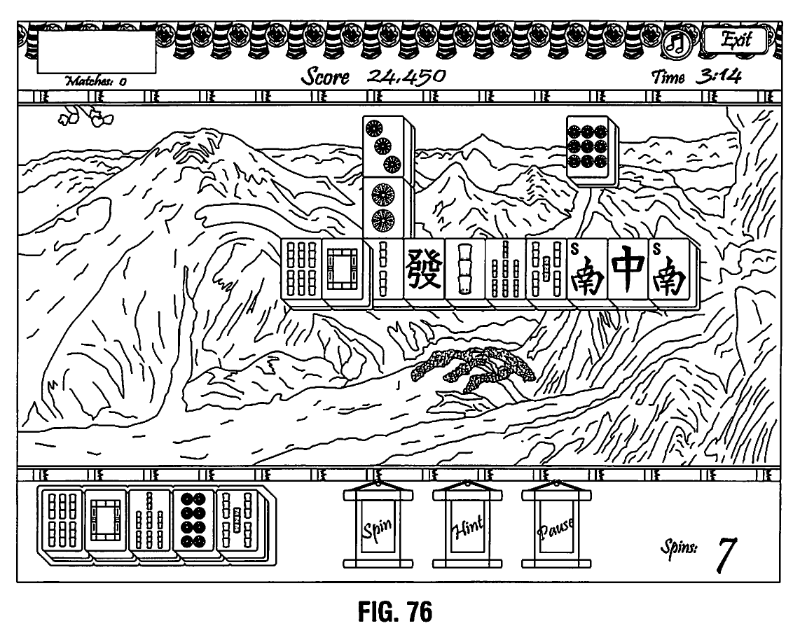

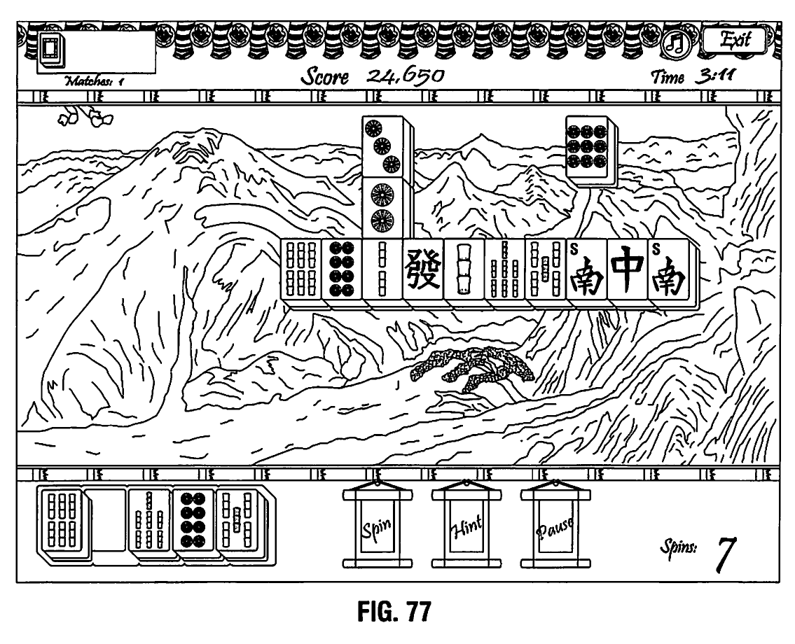

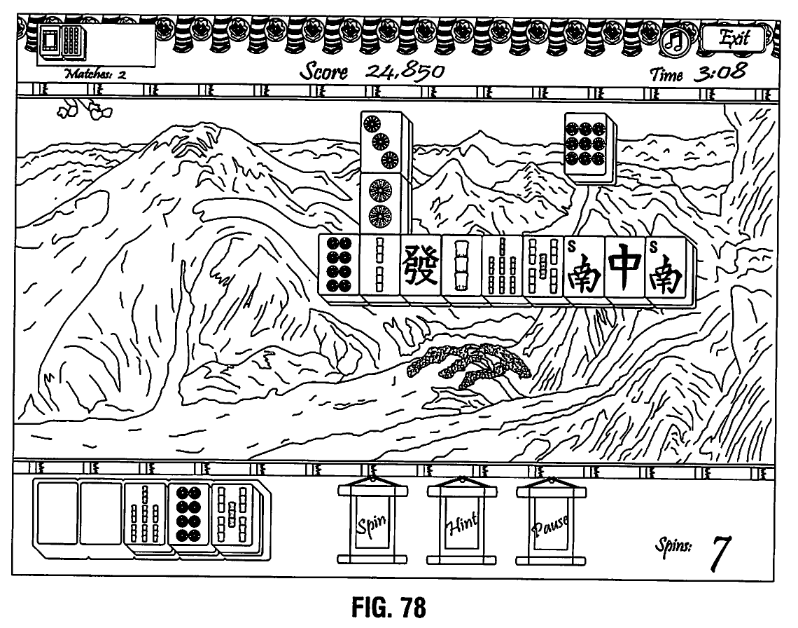

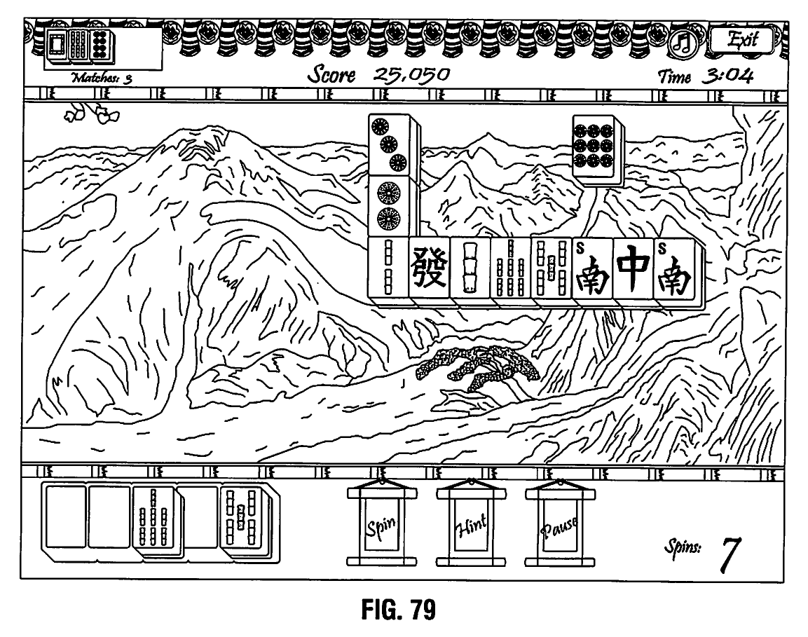

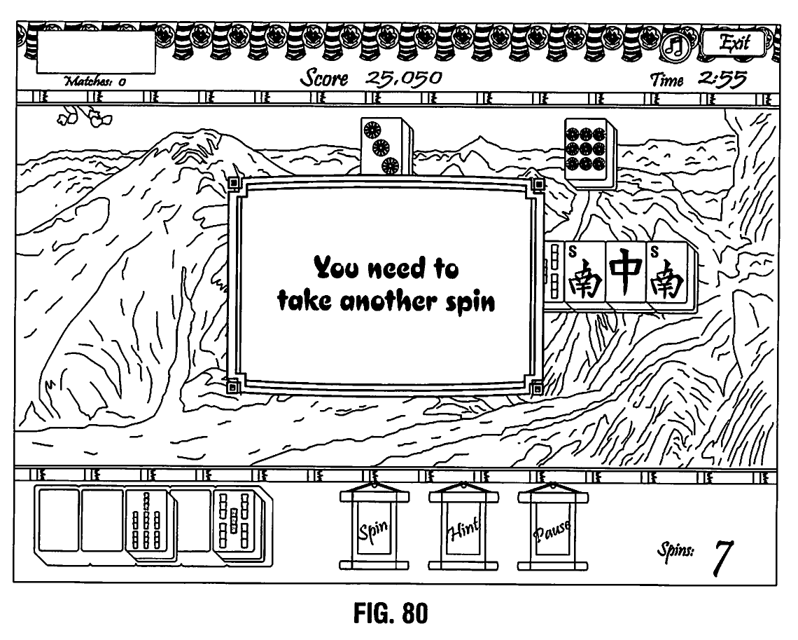

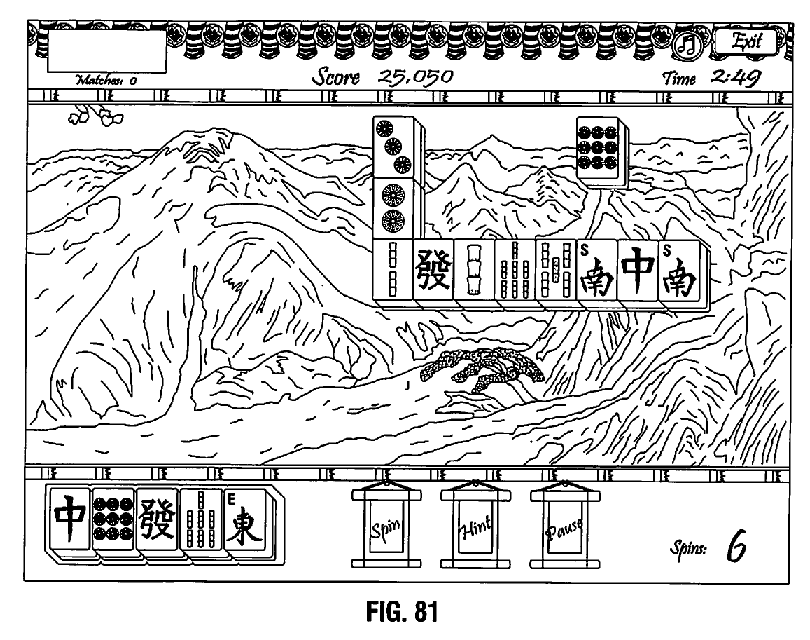

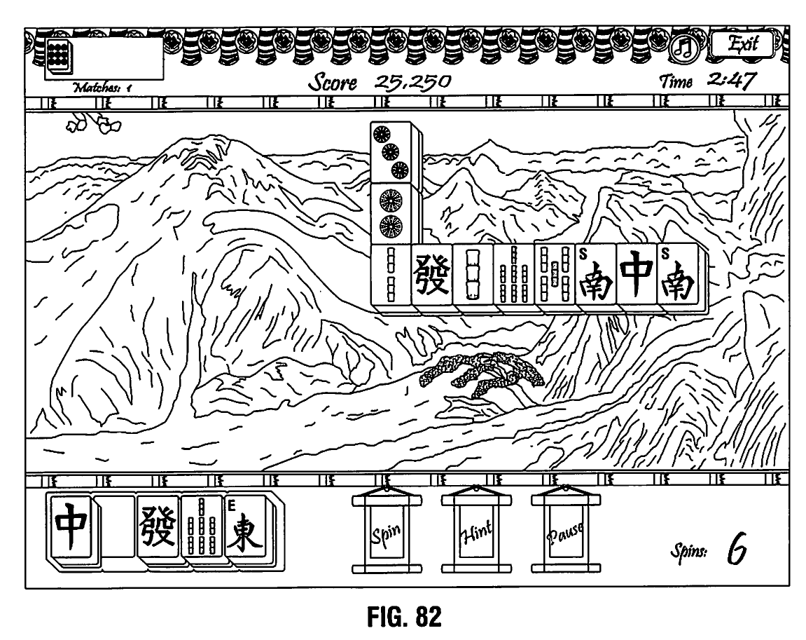

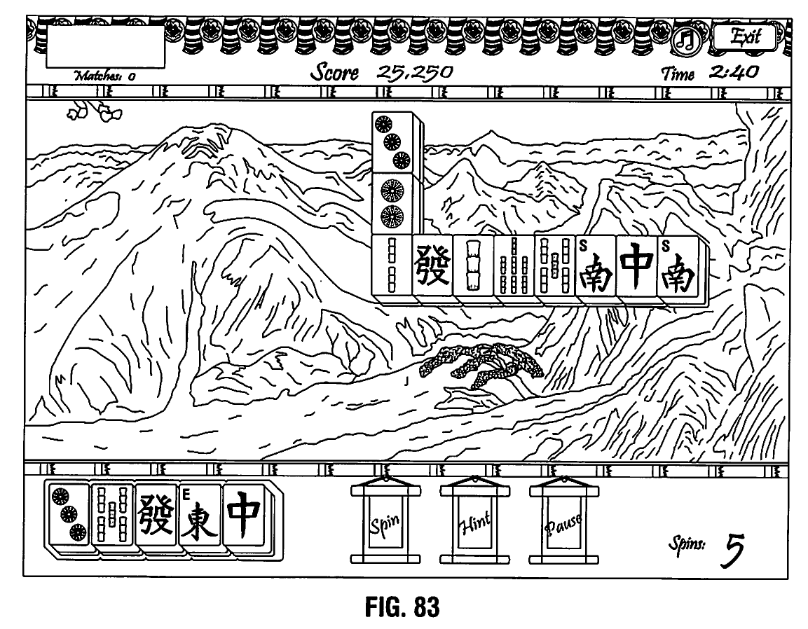

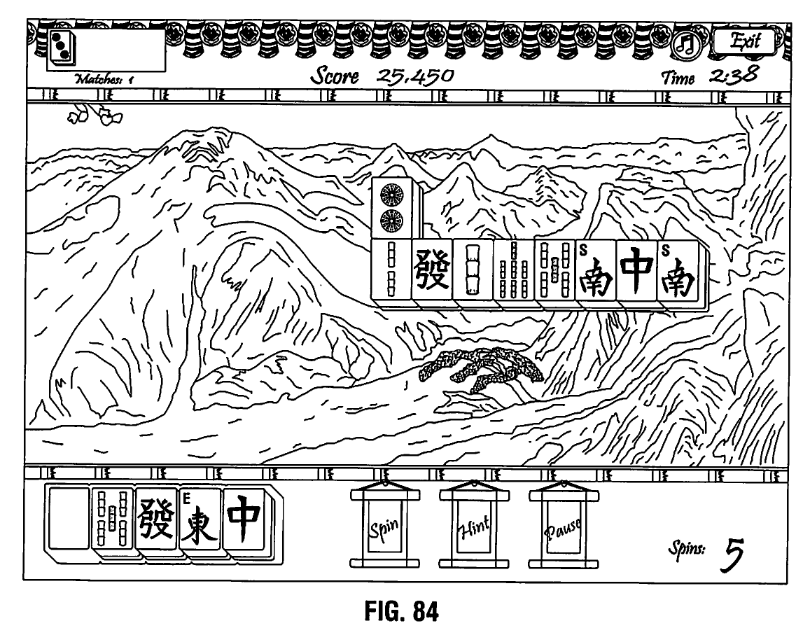

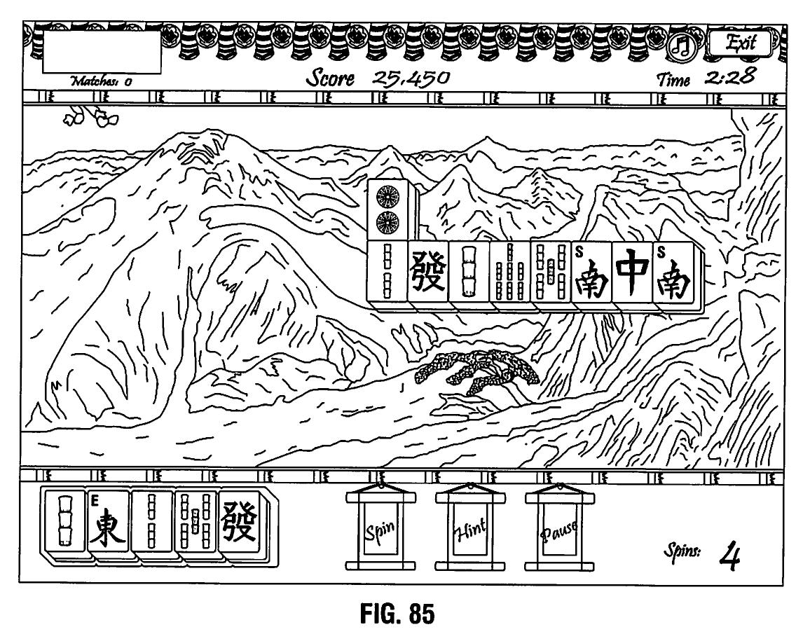

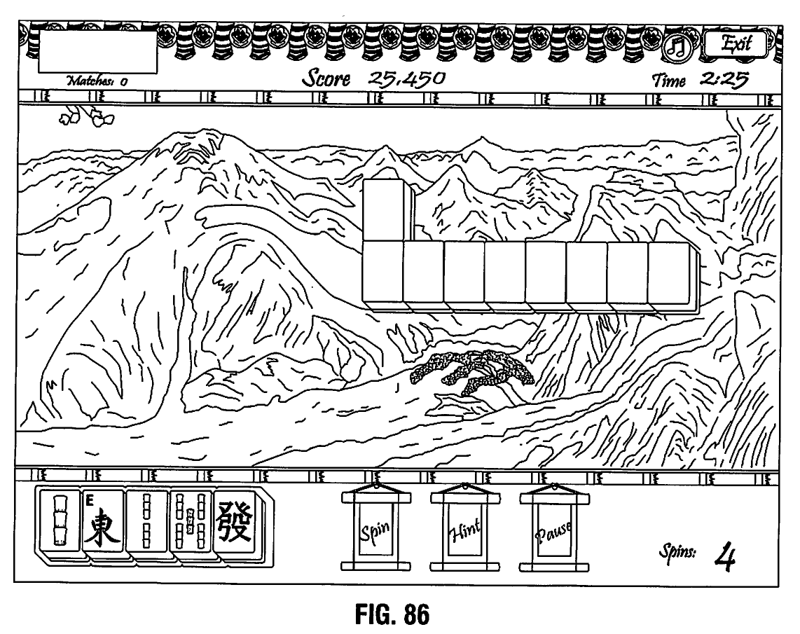

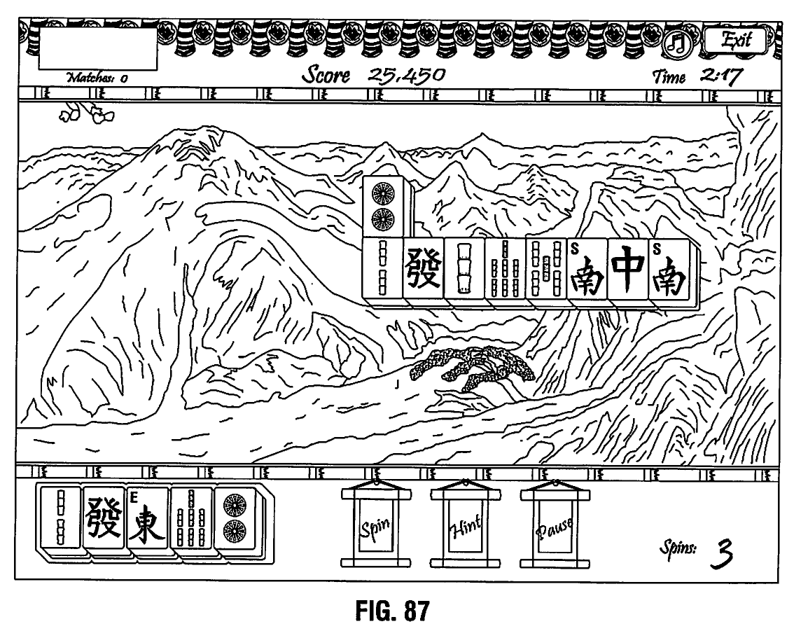

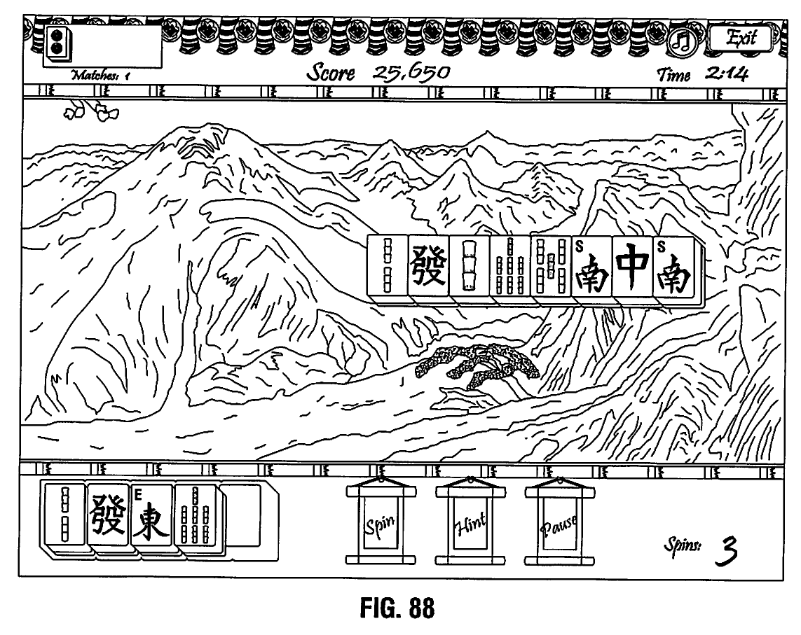

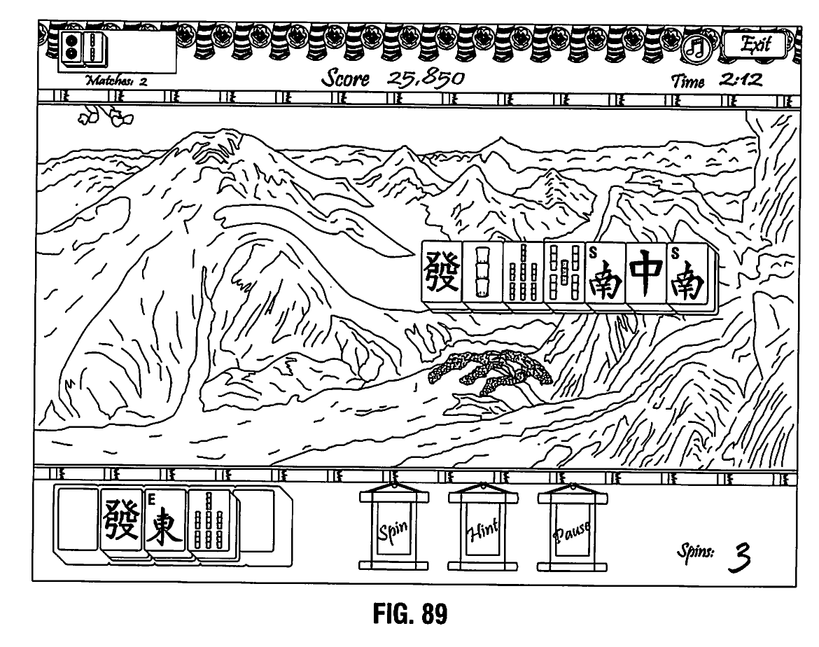

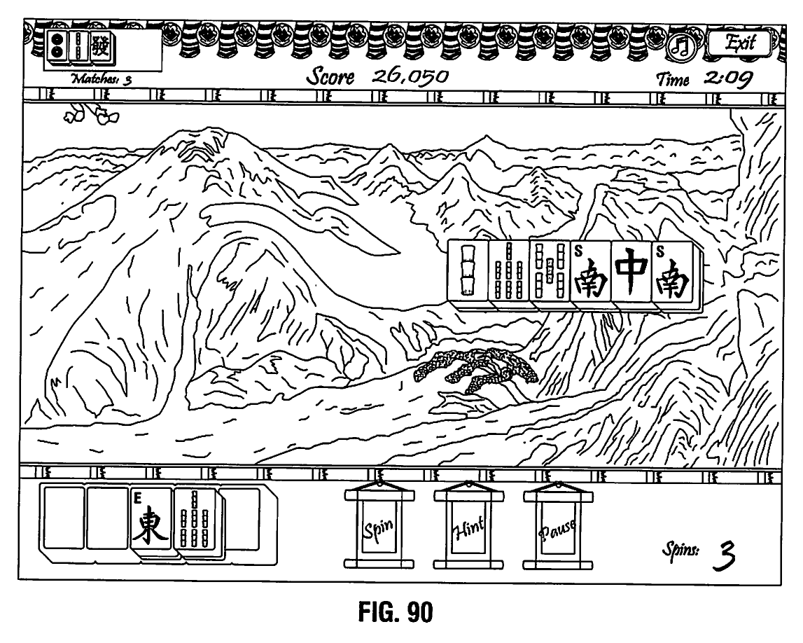

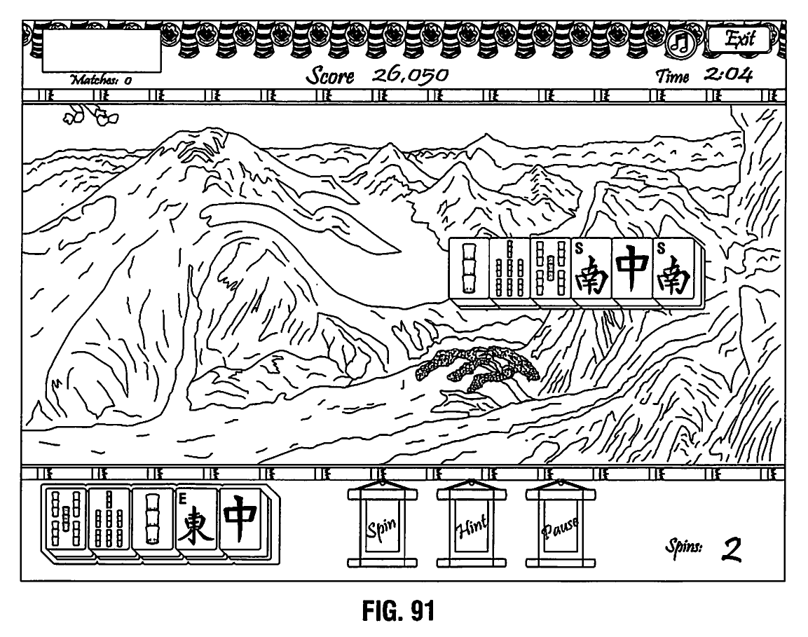

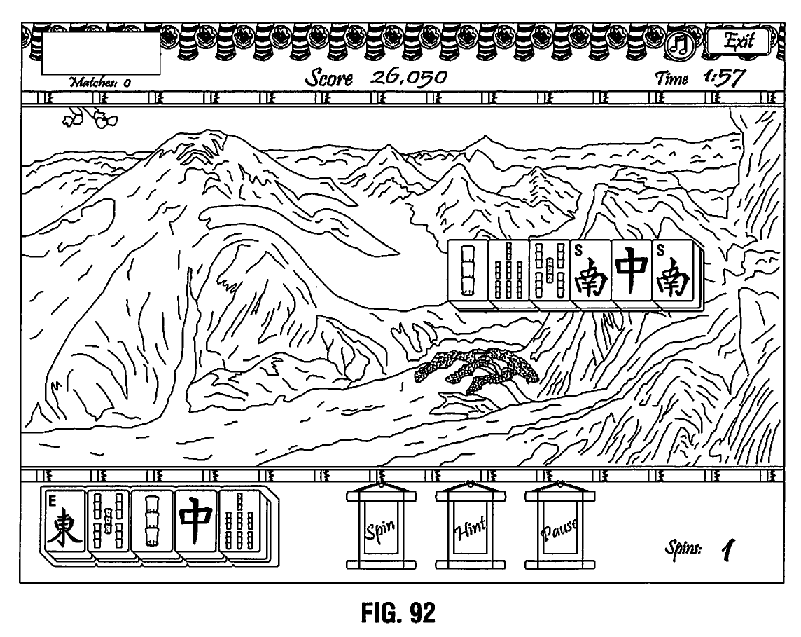

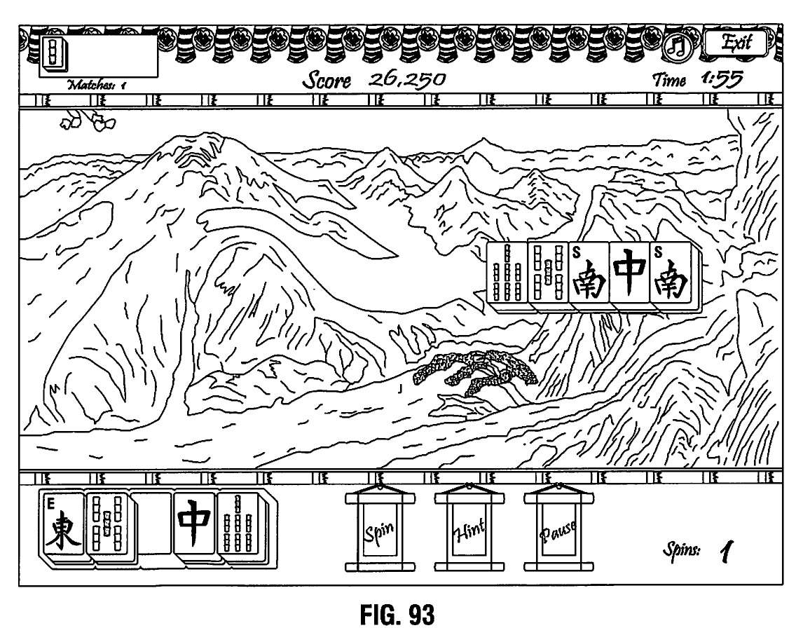

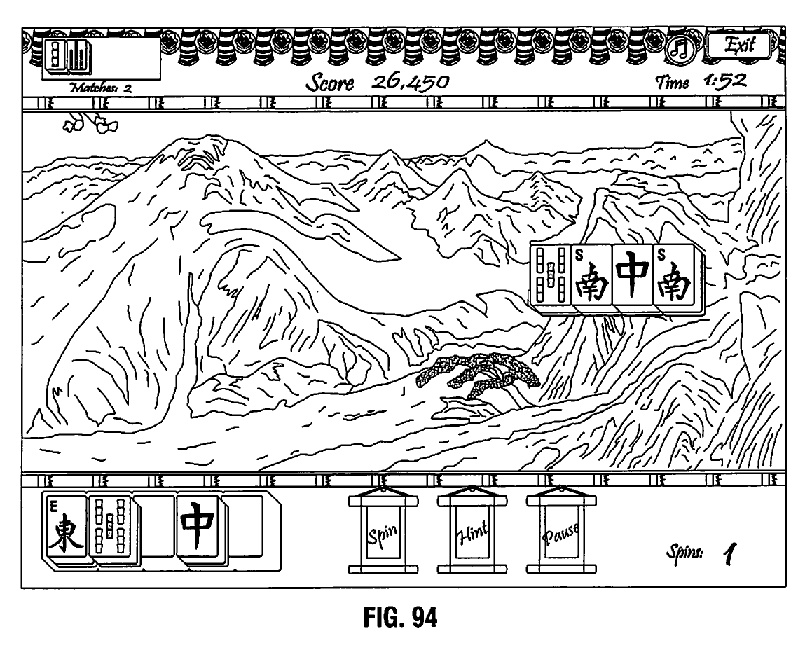

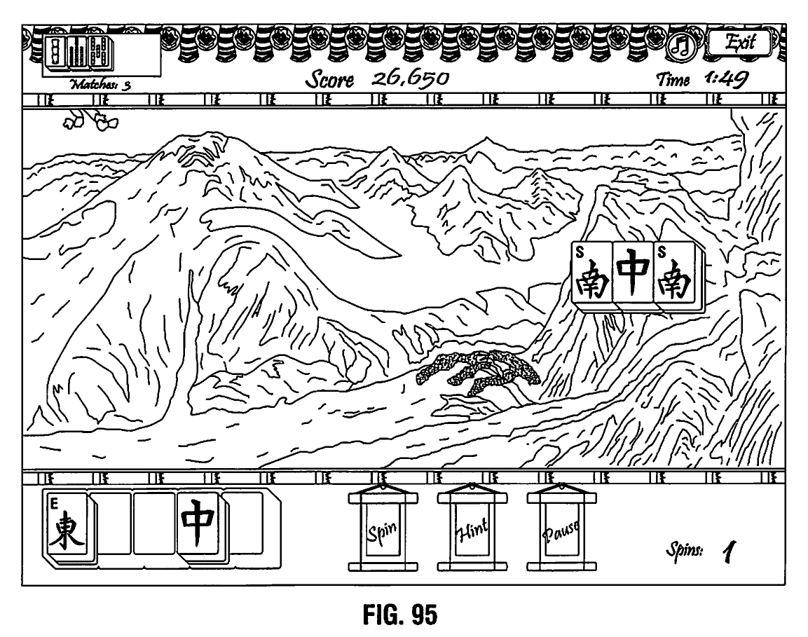

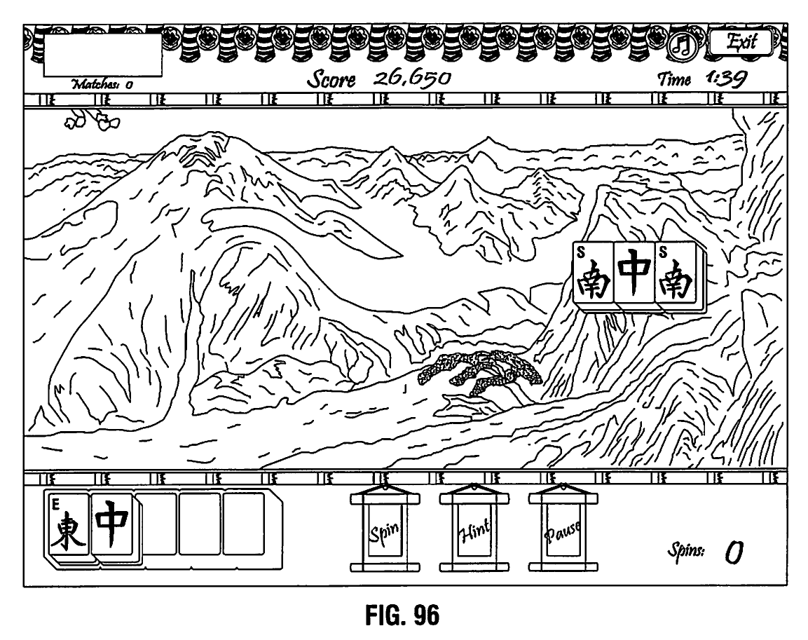

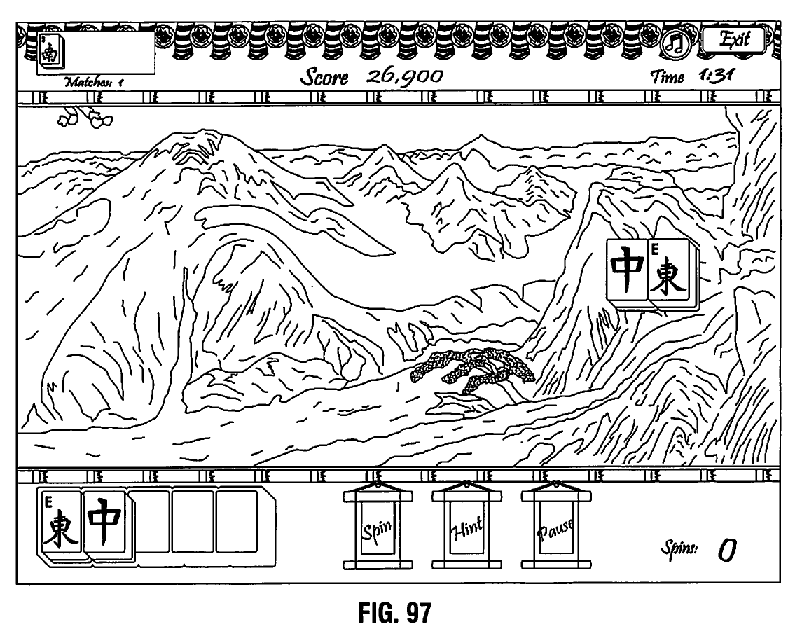

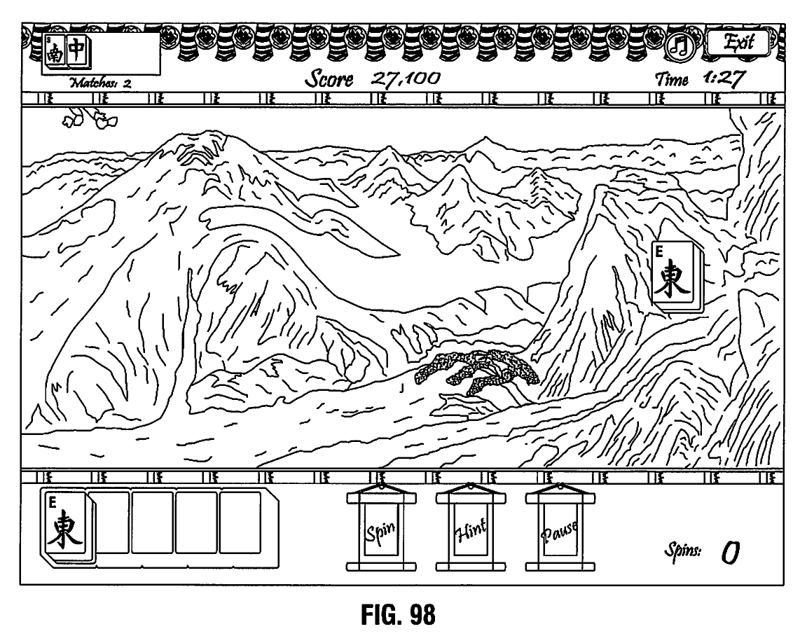

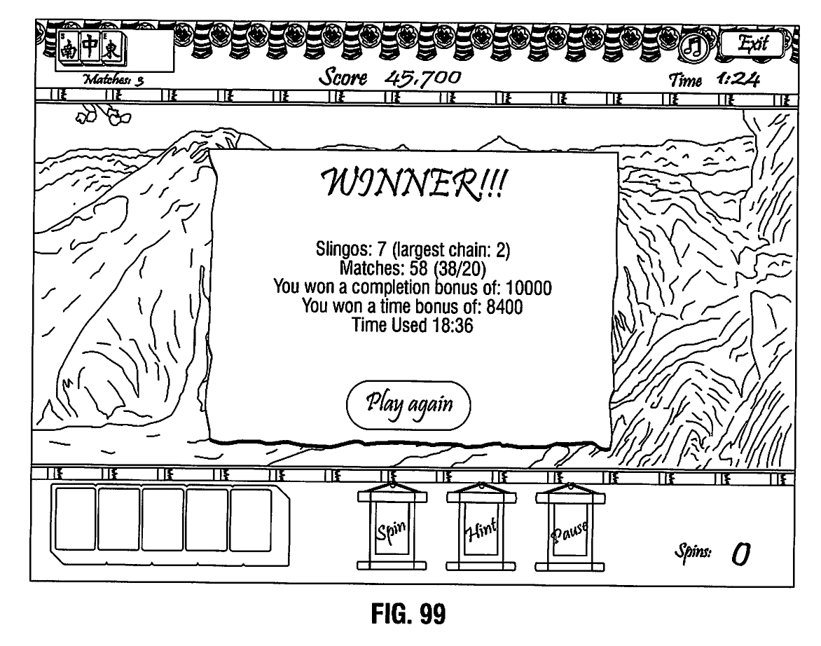

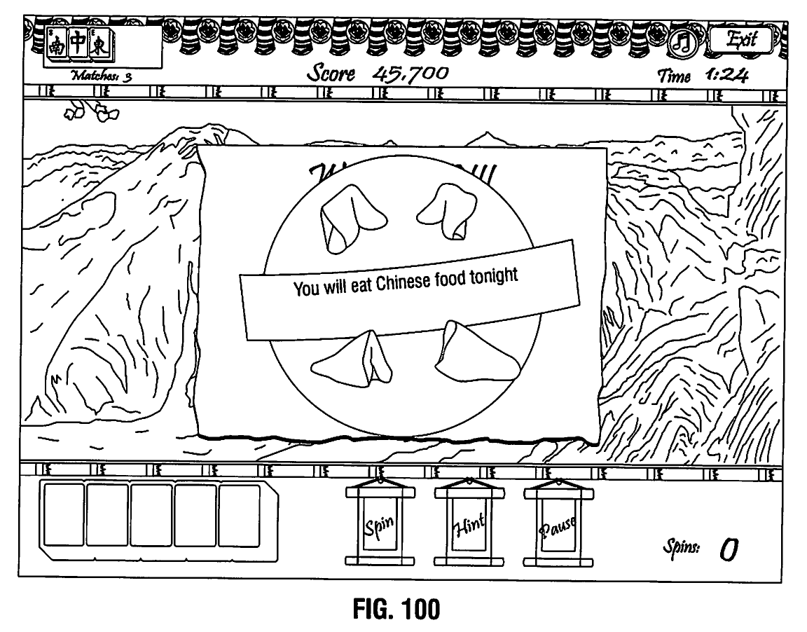

FIG. 100 shows the graphical user interface 100 displaying a graphic as an amusement to the player for clearing the tile layout 108.

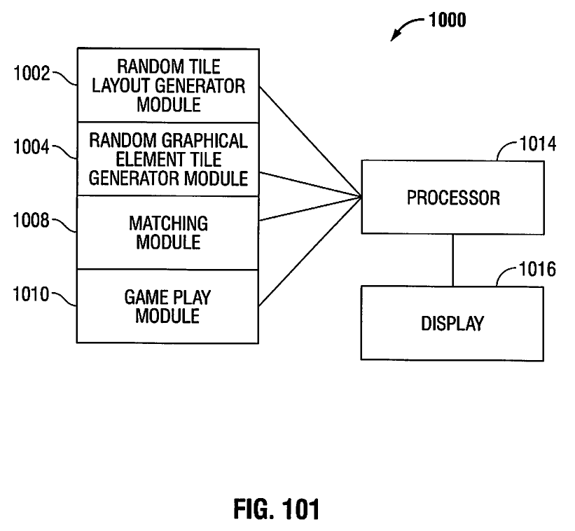

Referring to FIG. 101, there is shown an exemplary system 1000 for enabling play of a matching game in accordance with the present disclosure and as described hereinabove with reference to FIGS. 1-100.

System 1000 includes random tile layout generator module 1002, random graphical element tile generator module 1004, matching module 1008 and game play module 1010. The matching module 1008 determines if the player matched two selected tiles based on predetermined rules, such as rules corresponding to Mahjong solitaire, and the game play module 1010 provides play of the game by controlling game elements, such as the game clock 102, score counter 112, spin counter 116, match counter 118, and other game elements.

Each of the modules may be implemented as a set of instructions which are capable of being executed by processor 1014. Random tile layout generator module 1002 generates and graphically displays the tile layout 108. Random graphical element tile generator module 1004 generates and graphically displays the graphical elements 105A-105E upon the processor 1014 receiving a user input via the “SPIN” icon 106. The graphical user interface 100 is displayed to the player via a display 1016.

The system 1000 can be a network system having a server accessible via a network by at least one computing device, such as a personal computer, and a mobile computing device. A player can access the server via a computing device to play the game either individually or with at least one other player.

The system 1000 can also be a stand-alone casino machine, such as a slot machine, where the player is able to spin the game reels 104A-104E to display graphical elements 105A-105E for matching to the tile layout 108. The machine can be capable of receiving bets from at least one player and paying out credits redeemable for money. According to the bet made, the player is given X number of spins; the more the player bets, the more spins he is given and accordingly his likelihood of matching all tiles displayed by the tile layout 108 increases.

The machine can be networked to a plurality of other stand-alone casino machines enabling the accumulation of a progressive jackpot and awarding of the progressive jackpot. The progressive jackpot can be accumulated by diverting a percentage (e.g., 5%) of each bet made from each of the networked machines to the progressive jackpot. The awarding of the progressive jackpot can occur when a player bets max (selecting a “BET MAX” button) and in the following spin, the player is able to match every graphical element displayed by the game reels 104A-104E with a tile displayed by the tile layout 108. The progressive jackpot can also be awarded if the player clears the tile layout 108 by matching every tile in the tile layout 108.

The matching game described herein can be implemented as a primary game or as a bonus game. As added excitement, the number of spins can be determined by the player selecting a tile displayed by graphical user interface 100 which uncovers the number of spins. Additionally, when the game begins two or more different tile layouts can be displayed and the player selects which tile layout he wants to play.

The matching game described herein can be provided as a set of processor executable instructions stored on a computer-readable medium, such as, e.g., a CD-ROM, a hard drive, a smart card, and a flash memory media.

It will be understood that various modifications may be made to the embodiments disclosed herein, and that the above descriptions should not be construed as limiting, but merely as exemplifications of preferred embodiments. Those skilled in the art will envision other modifications within the scope and spirit of the claims appended hereto.

What is claimed is:

1. A method for playing a matching game comprising the steps of:
displaying a layout of pictorial graphical elements and a set of game reels;
receiving at least one input and displaying via a graphical user interface a pictorial graphical element in each of the set of game reels;
determining whether a graphical element of the layout of graphical elements and a graphical element of the set of game reels form a match in accordance with predetermined rules;
identifying a match having been made if it is determined that the graphical element of the layout of graphical elements and the graphical element of the set of game reels form a match in accordance with predetermined rules; and
awarding points after at least one match has been identified to have been made.

2. The method according to claim 1, further comprising the step of repeating at least the last four steps until a predetermined criterion is met, wherein the predetermined criterion is selected from the group consisting of: all graphical elements of the layout are matched; no remaining graphical elements can be matched; a game clock clocks a predetermined time period; a predetermined number of spins are used for displaying a graphical element in at least one of the set of game reels; and a predetermined number of spins and additional awarded spins are used for displaying a graphical element in at least one of the set of game reels.

3. The method according to claim 1, wherein the step of awarding points awards a different amount of points based on whether the match is between two graphical elements of the layout or whether the match is between a graphical element of the layout and a graphical element of the set of game reels.

4. The method according to claim 2, wherein points are awarded based on point multipliers, and wherein at least one free spin is awarded based on satisfying a predetermined condition.

5. The method according to claim 1, wherein the graphical elements are indicative of Mahjong tiles and the predetermined rules are rules corresponding to Mahjong solitaire.

6. The method according to claim 1, further comprising the steps of:
counting the number of consecutive matches;
determining if a predetermined number of consecutive matches is achieved; and
awarding points if a predetermined number of consecutive matches is achieved.

7. The method according to claim 6, further comprising the steps of:
counting the number of consecutive times the predetermined number of consecutive matches is achieved; and
awarding points after each such achievement.

8. A system for playing a matching game at least partially implemented by an operative set of processor executable instructions configured for execution by at least one processor, comprising:
a random layout generator module for generating and displaying a layout having a plurality of pictorial graphical elements;
a random graphical element generator module for generating and displaying a pictorial graphical element on each of a set of game reels; and
a matching module for determining whether at least two displayed graphical elements match in accordance with predetermined rules, wherein one of the at least two displayed graphical elements is a graphical element generated by the random layout generator module and another of the at least two displayed graphical elements is a graphical element generated by the random graphical element generator module.

9. The system according to claim 8, further comprising a game play module for controlling game elements, wherein the game elements include a game clock, a score counter, a spin counter for displaying the number of spins available to a player, and a match counter for displaying the number of consecutive matches.

10. The system according to claim 8, wherein the system is a network system having a server accessible via a network by at least one computing device.

11. A system for enabling play of a matching game comprising a processor configured for executing instructions for performing the steps of:
displaying a layout of pictorial graphical elements and a set of game reels;
receiving at least one input and displaying via a graphical user interface a pictorial graphical element in each of the set of game reels;
determining whether a graphical element of the layout of graphical elements and a graphical element of the set of game reels form a match in accordance with predetermined rules;
identifying a match having been made if it is determined that the graphical element of the layout of graphical elements and the graphical element of the set of game reels form a match in accordance with predetermined rules; and
awarding points after at least one match has been identified to have been made.

12. The system according to claim 11, further comprising the step of repeating at least the last four steps until a predetermined criterion is met, wherein the predetermined criterion is selected from the group consisting of: all graphical elements of the layout are matched; no remaining graphical elements can be matched; a game clock clocks a predetermined time period; a predetermined number of spins are used for displaying a graphical element in at least one of the set of game reels; and a predetermined number of spins and additional awarded spins are used for displaying a graphical element in at least one of the set of game reels.

13. The system according to claim 11, wherein the method further comprises the step of awarding points based on point multipliers, and wherein at least one free spin is awarded based on satisfying a predetermined condition.

14. The system according to claim 11, wherein the graphical elements are indicative of Mahjong tiles and the predetermined rules are rules corresponding to Mahjong solitaire.

15. The system according to claim 11, wherein the method further comprises the steps of:
counting the number of consecutive matches;
determining if a predetermined number of consecutive matches is achieved; and
awarding points if a predetermined number of consecutive matches is achieved.

16. The system according to claim 15, wherein the method further comprises the steps of:
counting the number of consecutive times the predetermined number of consecutive matches is achieved; and
awarding points after each such achievement.

17. A system for playing a matching game comprising:
means for displaying a layout of pictorial graphical elements and a set of game reels;
means for receiving at least one input and displaying via a graphical user interface a pictorial graphical element in each of the set of game reels;
means for determining whether a graphical element of the layout of graphical elements and a graphical element of the set of game reels form a match in accordance with predetermined rules;
means for identifying a match having been made if it is determined that the graphical element of the layout of graphical elements and the graphical element of the set of game reels form a match in accordance with predetermined rules; and
means for awarding points after at least one match has been identified to have been made.

18. The system according to claim 17, further comprising means for repeating at least the last four steps until a predetermined criterion is met, wherein the predetermined criterion is selected from the group consisting of: all graphical elements of the layout are matched; no remaining graphical elements can be matched; a game clock clocks a predetermined time period; a predetermined number of spins are used for displaying a graphical element in at least one of the set of game reels; and a predetermined number of spins and additional awarded spins are used for displaying a graphical element in at least one of the set of game reels.

19. The system according to claim 17, further comprising means for awarding points based on point multipliers, and wherein at least one free spin is awarded based on satisfying a predetermined condition.

20. The system according to claim 17, wherein the graphical elements are indicative of Mahjong tiles and the predetermined rules are rules corresponding to Mahjong solitaire.

21. The system according to claim 17, further comprising:
means for counting the number of consecutive matches;
means for determining if a predetermined number of consecutive matches is achieved; and
means for awarding points if a predetermined number of consecutive matches is achieved.

22. The system according to claim 21, wherein the system further comprises:
means for counting the number of consecutive times the predetermined number of consecutive matches is achieved; and
means for awarding points after each such achievement.

23. A computer-readable medium storing a set of processor-executable instructions for performing a method comprising:
displaying a layout of pictorial graphical elements and a set of game reels;
receiving at least one input and displaying via a graphical user interface a pictorial graphical element in each of the set of game reels;
determining whether a graphical element of the layout of graphical elements and a graphical element of the set of game reels form a match in accordance with predetermined rules;
identifying a match having been made if it is determined that the graphical element of the layout of graphical elements and the graphical element of the set of game reels form a match in accordance with predetermined rules; and
awarding points after at least one match has been identified to have been made.

24. The computer-readable medium according to claim 23, further comprising the step of repeating at least the last four steps until a predetermined criterion is met, wherein the predetermined criterion is selected from the group consisting of: all graphical elements of the layout are matched; no remaining graphical elements can be matched; a game clock clocks a predetermined time period; a predetermined number of spins are used for displaying a graphical element in at least one of the set of game reels; and a predetermined number of spins and additional awarded spins are used for displaying a graphical element in at least one of the set of game reels.
